(19) United States
(12) Patent Application Publication
(10) Pub. No.: US 2019/0254302 A1
(43) Pub. Date: Aug. 22, 2019

(54) SYSTEMS AND METHODS FOR CONTROLLING THE RELEASE FROM ENZYME-RESPONSIVE MICROCAPSULES WITH A SMART NATURAL SHELL

(71) Applicant: Cornell University, Ithaca, NY (US)

(72) Inventors: Alireza ABBASPOURRAD, Ithaca, NY (US); Raheleh RAVANFAR, Ithaca, NY (US)

(21) Appl. No.: 16/255,303

(22) Filed: Jan. 23, 2019

Related U.S. Application Data
(60) Provisional application No. 62/620,651, filed on Jan. 23, 2018.

(51) Int. Cl. A23C 19/09; A23L 5/44; A23L 5/48; A23C 19/084; A23C 19/068

(52) U.S. Cl. CPC A23C 19/0925; A23V 2300/26; A23L 5/48; A23C 19/084; A23C 19/0686; A23C 2210/40; A23V 2002/00; A23V 2200/044; A23V 2200/224; A23V 2250/211; A23V 2250/50364; A23V 2250/54246; A23V 2250/1618; A23V 2250/161; A23V 2250/1582; A23V 2250/1578; A23V 2300/34; A23L 5/44

(57) ABSTRACT

The present application relates to a microcapsule comprising a core comprising one or more hydrophobic agents dispersed in a gel matrix; a proteolytically-cleavable outer polymer shell surrounding said core; and an enzymatically-cleavable lipid layer between said core and said shell. Also described are methods of making and using the microcapsules.

This application claims the benefit of U.S. Provisional Patent Application Ser. No. 62/620,651, filed Jan. 23, 2018, which is hereby incorporated by reference in its entirety.

### FIELD

Described are microcapsules comprising a core, a proteolytically-cleavable outer polymer shell, and an enzymatically-cleavable lipid layer as well as methods of making and using the microcapsules.

### BACKGROUND

The following description is provided to assist the understanding of the reader. None of the information provided or references cited is admitted to be prior art to the present technology.

Encapsulation of materials such as colors, vitamins, flavors, natural antioxidants, drugs, imaging agents, and other small molecules has been extensively studied in a variety of systems, and is considered to be an ideal platform for delivery of bioactive compounds. Current capsule synthesis methods use polymers or lipids to fabricate self-assembled or emulsion-based particles, which release the bioactive compounds through diffusion or hydrolytic degradation. Although significant progress has been made in biopolymeric or liposomal encapsulation systems, there are critical limitations in synthesizing carriers with highly controllable architecture that are released by environmentally-triggered mechanisms. The ability to precisely manipulate the composition and release mechanism of microcapsules is essential for controlling their transport, distribution, and release efficacy in different systems.

Armed with a better understanding of various responsive mechanisms in biological systems, researchers have developed innovative delivery platforms with smart materials that are sensitive to specific stimuli (Rosenbauer et al., “Controlled Release from Polyurethane Nanocapsules via pH-, UV-Light- or Temperature-Induced Stimuli,” Macromolecules 43(11):5083-5093 (2010); Abbaspourrad et al., “Polymer Microcapsules With Programmable Active Release,” Journal of the American Chemical Society 135(20):7744-7750 (2013); Abbaspourrad et al., “Controlling Release From pH-Responsive Microcapsules,” Langmuir 29(41):12697-12702 (2013); Hoffman, A. S., “Stimuli-Responsive Polymers: Biomedical Applications and Challenges for Clinical Translation,” Advanced Drug Delivery Reviews 65(1):10-16 (2013); Ravanfar et al., “Preservation of Anthocyanins in Solid Lipid Nanoparticles: Optimization of a Microemulsion Dilution Method Using the Placket-Burman and Box-Behnken Designs,” Food Chemistry 199:573-580 (2016); and Comunian et al., “Improving Oxidative Stability of Echium Oil Emulsions Fabricated by Microfluidics: Effect of Ionic Gelation and Phenolic Compounds,” Food Chemistry 233:125-134 (2017). Application of these platforms demands a biocompatible structure with the ability to communicate with cells, improve the anti-inflammation capability, and prevent the formation of biofilms or fibrosis (Wang et al., “Hierarchical Targeting Strategy for Enhanced Tumor Tissue Accumulation/Retention and Cellular Internalization,” Advanced Materials 28(34):7340-7364 (2016) and Lu et al., “Bioresponsive Materials,” Nature Reviews Materials 2:16075 (2016)). Although significant progress has been made in biopolymeric or liposomal encapsulation systems (Allen et al., “Liposomal Drug Delivery Systems: From Concept to Clinical Applications,” Advanced Drug Delivery Reviews 65(1):36-48 (2013); Yingchoncharoen et al., “Lipid-Based Drug Delivery Systems in Cancer Therapy: What is Available and What is Yet to Come,” Pharmacological Reviews 68(3):701-787 (2016); Imran et al., “Liposomal Nanodelivery Systems Using Soy and Marine Lecithin to Encapsulate Food Biopreservative Nisin,” LWT-Food Science and Technology 62(1):341-349 (2015); Joye et al., “Biopolymer-Based Nanoparticles and Microparticles: Fabrication, Characterization, and Application,” Current Opinion in Colloid & Interface Science 19(5):417-427 (2014); Mehrad et al., “Enhancing the Physicochemical Stability of β-Carotene Solid Lipid Nanoparticle (SLNP) Using Whey Protein Isolate,” Food Research International (2017); Comunian et al., “Influence of the Protein Type on the Stability of Fish Oil in Water Emulsion Obtained by Glass Microfluidic Device,” Food Hydrocolloids (2017); and Ravanfar et al., “Optimization of Microcapsules Shell Structure to Preserve Labile Compounds: A Comparison Between Microfluidics and Conventional Homogenization Method,” Food Chemistry 241:460-467 (2018)), there are critical limitations in synthesizing biocompatible capsules with highly controllable architectures and release mechanisms in complex biological systems.

Owing to the varied roles that enzymes have in different biological processes, enzyme-associated platform designs have recently become an emerging strategy for controlled delivery and release (Lu et al., “Bioresponsive Materials,” Nature Reviews Materials 2:16075 (2016)). For example, the incorporation of ester bonds in the structure of the carriers can target esterases for site-specific release (Lu et al., “Bioresponsive Materials,” Nature Reviews Materials 2:16075 (2016)). However, the incorporation of these enzyme-specific moieties in the platform requires organic synthesis steps, which are usually intricate, expensive, and time-consuming. Consequently, there is opportunity for designing simple, cost-effective platforms that respond to a specific enzyme and actuate a controlled release pattern.

The present application is directed to overcoming these and other deficiencies in the art.

### SUMMARY

One aspect of the present application relates to a microcapsule comprising a core comprising one or more hydrophobic agents dispersed in a gel matrix; a proteolytically-cleavable outer polymer shell surrounding said core; and an enzymatically-cleavable lipid layer between said core and said shell.

Another aspect of the present application relates to a method of preparing a microcapsule. This method involves dispersing one or more hydrophobic agents into an aqueous solution of a hydrophilic non-ionic surfactant and a gel matrix to produce an oil-in-water (o/w) single emulsion; mixing the o/w single emulsion with one or more lipids to produce an oil-in-water-in-oil (o/w/o) double emulsion; blending the o/w/o double emulsion with a secondary aqueous solution to produce an oil-in-water-in-oil-in-water (o/w/o/w) triple microemulsion; drying the o/w/o/w triple microemulsion to form a dried triple microemulsion; and incubating the dried triple microemulsion to form microcapsules each comprising one or more hydrophobic agents in a hydrophilic aqueous core surrounded by a proteolytically-cleavable outer polymer shell with an enzymatically-cleavable lipid layer between said core and said shell.

A further aspect of the present application relates to a method of selectively coloring cheese curd. This method involves adding a plurality of microcapsules according to the present application to milk to produce a mixture, wherein the plurality of microcapsules comprise one or more hydrophobic coloring agents; acidifying the mixture; coagulating the acidified mixture to generate a curd fraction and a whey fraction; separating the curd fraction from the whey fraction; and ripening the curd to obtain a colored cheese curd.

Another method of the present application relates to a method of selectively delivering a hydrophobic agent to a food product. This method involves providing a food product; adding a plurality of microcapsules according to the present application to the food product to produce a mixture; and exposing the mixture to proteolytic and enzymatic conditions to produce a modified food product treated with the one or more hydrophobic agents.

Yet another aspect of the present application relates to a method of treating a subject with one or more hydrophobic agents. This method involves selecting a subject in need of treatment and administering a plurality of microcapsules according to the present application to the selected subject, wherein the plurality of microcapsules are subjected to proteolytic and enzymatic conditions, thereby releasing the one or more hydrophobic agents in the subject.

The Examples of the present application provide a simple microcapsule design containing an enzymatically degradable shell, which provides the release of encapsulated compounds in response to lipase. This microcapsule can also transport its cargo to the desired region of the biological system without being affected by environmental conditions. Microcapsules are fabricated using a triple oil-in-water-in-oil-in-water (o/w/o/w) microemulsion. The microcapsule core contains oil-soluble cargo in a gel matrix. The microcapsule shell contains an inner lipid layer and an outer polymer layer. Using natural lipids containing ester bonds in the lipid layer of the microcapsule shell, microcapsules that specifically release their content in the presence of lipase are fabricated. The polymer layer is engineered according to the biochemical environment of the biological system and guarantees the transportation and distribution of microcapsules to their desired site. This delivery platform could be used in different industrial and biological applications.

To demonstrate the performance of the disclosed microcapsules, Cheddar cheese was selected as a model system. Lipases are mainly found in cheese curds during cheese ripening and are responsible for producing short-chain fatty acids, which contribute to the flavor. Microcapsules of the present application were used to selectively deliver color to the cheese curd by lipase-triggered release, leaving the whey fraction colorless. To achieve these results, oil-soluble bixin was incorporated into a κ-carrageenan gel matrix. The lipid layer of the microcapsule shell comprised beeswax-palmitic acid. The ester bonds in this lipid layer were broken by lipase during cheese ripening and color was released from the microcapsules into the cheese matrix. The polymer layer comprised casein and poloxamer 338, which was vulnerable to protease and was disintegrated by rennet during the coagulation step of the cheese-making process. The presence of casein in the polymer layer also guaranteed the transport of microcapsules to the cheese curd along with the other casein molecules of the milk. Thus, the encapsulated color was delivered primarily to the cheese curd fraction and the recovered whey proteins remained white. Since the current industrial method to eliminate the yellow color of Cheddar cheese whey requires the use of oxidizing agents, such as hydrogen peroxide, obtaining a white whey fraction through the enzyme-responsive microcapsule approach disclosed herein is of significant interest to the food industry. Exploiting this approach, white whey was recovered without the use of any oxidizing agents, thereby enhancing the nutritive value and flavors in the white whey.

### BRIEF DESCRIPTION OF THE DRAWINGS

FIG. 1 is a schematic illustration of a spray-drying setup.

FIG. 2 is a schematic illustration of enzymatically-triggered microcapsules and their controlled-release by lipase.

FIG. 3 shows the proposed mechanism for de-esterification of triacontanyl palmitate by lipase.

FIG. 4 shows the size distribution of microcapsules.

FIG. 5 is a X-ray diffraction spectra of the microcapsule and shell materials.

FIGS. 6A-6F are images of microcapsules. FIG. 6A was taken using light microscopy. FIGS. 6B-6C were taken using scanning electron microscopy. FIG. 6C is an enlarged image of the inset in FIG. 6B. FIGS. 6D-6F are cryo-scanning electron microscopy images of a microcapsule cross-sectioned by focused ion beam. FIG. 6E is an enlarged image of the inset in FIG. 6D. FIG. 6F is an enlarged image of the inset in FIG. 6E.

FIG. 7 shows additional light microscopy and electron microscopy images of microcapsules.

FIGS. 8A-8B are graphs showing bixin release patterns from microcapsules exposed to lipase, protease, or a combination of both lipase and protease over 14 days. FIG. 8A shows the concentration of bixin in mg/ml in the medium. FIG. 8B shows the release (%) of bixin from microcapsules.

FIG. 9 shows the simulation of the Cheddar cheese-making process for whole milk containing the enzymatically-triggered microcapsules.

FIG. 10 shows the stimulation of a cheddar cheese making process for whole milk containing microcapsules obtained from different formulations

FIG. 11 shows images of cheese curd containing microcapsules after 14 days incubation at 26° C. (right panel); with lipase (left); and without lipase (control; center).

FIG. 12 shows the FTIR spectra of cheese curd with and without lipase after one day incubation at 26° C. Arrows indicate the control plot line.

FIG. 13 shows microcapsules with the gel matrix of gelatin. The arrows show the microcapsules encapsulated bixin in gelatin matrix, with a lipid layer of palmitic acid/beeswax.

FIGS. 14A-14B shows microcapsules with a lipid layer of glycerol monooleate. FIG. 14A shows microcapsules with a hydrophilic aqueous core surrounded by a lipid layer of glycerol monooleate and polymer layer of maltodextrin/poloxamer. FIG. 14B is a magnified image of 14A.

FIG. 15 shows the X-ray diffraction spectra of microcapsules containing glycerol monooleate (GMO).

FIGS. 16A-16B show images of microcapsules with the polymer layer of maltodextrin. FIG. 16A is an image of microcapsules with a hydrophilic aqueous core surrounded by a lipid layer of palmitic acid/lecithin and polymer layer of casein/maltodextrin. FIG. 16B is an image of microcapsules with a hydrophilic aqueous core surrounded by a lipid layer of glycerol monooleate/lecithin and polymer layer of casein/maltodextrin.

FIG. 17 is a schematic image of using cross-linking agents in the outer layer. Top: The microcapsules with a lipid layer, surrounded by a protein layer immersed in a polysaccharide layer. Bottom: The left schematic shows the microcapsule with a lipid layer surrounded by a protein-polysaccharide complex cross-linked with a cross-linking agent. The right schematic shows the microcapsule with a lipid layer surrounded by a protein-polysaccharide complex without any crosslinking agent.

FIGS. 18A-18C demonstrates that microcapsules strengthen with cross-linking of protein-polysaccharide layer using the enzymatic cross linker (laccase; FIG. 18A) and CaCl₂ salt (FIG. 18B), in comparison with the non-treated microcapsules (control; FIG. 18C).

FIG. 19 shows the thermogravimetric analysis (TGA) of laccase-treated microcapsules in comparison with control.

### DETAILED DESCRIPTION

One aspect of the present application relates to a microcapsule comprising a core having one or more hydrophobic agents dispersed in a gel matrix; a proteolytically-cleavable outer polymer shell surrounding said core; and an enzymatically-cleavable lipid layer between said core and said shell.

As used herein, the term “microcapsule” refers to particles having a size (e.g., a diameter) of 1-1,000 μm, 1-500 μm, 1-200 μm, 1-100 μm, 1-50 μm, 1-25 μm, 1-10 μm, 1-9 μm, 2-9 μm, or 3-9μm. Ranges and values intermediate to the above recited ranges and values are also contemplated to be part of the invention.

The microcapsules of the present application may be made or manufactured using any technique known in the art, including emulsification techniques, spray drying techniques, water-in-oil-in-water techniques, syringe extrusion techniques, coaxial air flow methods, mechanical disturbance methods, electrostatic force methods, electrostatic bead generator methods, and/or droplet generator methods. For example, the microcapsules of the present application may be manufactured using techniques and methods similar to those described in U.S. Pat. No. 6,884,432, which is hereby incorporated by reference in its entirety.

The size and other properties of microcapsules may be changed by altering various parameters in the production process. Freidberg et al., “Polymer Microspheres for Controlled Drug Release,” 282(1-2):1-18 (2004) (which is hereby incorporated by reference in its entirety) provides a review of procedures and compositions for microsphere manufacture, any of which procedures and compositions may be used in conjunction with microcapsules of the present application.

The one or more hydrophobic agents may be selected from the group consisting of coloring agents, vitamins, flavoring agents, antioxidants, drugs, imaging agents, and combinations thereof.

As used herein, the term “hydrophobic agent” refers to compounds or substances which are capable of dissolving in fats, oils, lipids, or non-polar solvents (i.e., lipophilic or lipid-soluble compounds).

In some embodiments, the one or more hydrophobic agents comprise one or more vitamins. As used herein, the term “vitamin A” refers to any form of vitamin A, including but not limited to, retinol, retinaldehydes, retinal, retinoic acid (also known as tretinoin and retin-A), and vitamin A salts and derivatives (e.g., retinol palmitate, retinyl acetate, and β-carotene and other carotenoids). As used herein, the term “vitamin D” refers to any form of vitamin D, including but not limited to, ergocalciferol (D₂), cholecalciferol (D₃), 22,23-dihydroergocalciferol (D₄), and vitamin D salts and derivatives (e.g., 25-hydroxycholecalciferol and 1-a,25-dihydroxycholecalciferol). As used herein, the term “vitamin E” refers to the family of compounds known as tocopherols (e.g., ot-tocopherol, β-tocopherol, δ-tocopherol, γ-tocopherol), as well as tocol, tocoquinone, tocotrienol, and vitamin E salts (e.g., vitamin E phosphate) and derivatives (e.g., tocopherol sorbate, tocopherol acetate, tocopherol succinate, other tocopherol esters). As used herein, the term “vitamin K” refers to vitamin K₁ (phytonadione), vitamin K₂ (menaquinone), vitamin K₃ (menadione), vitamin K₄, vitamin K₅, vitamin K₆, vitamin K₇, and their salts and derivatives. Suitable vitamins for use in the microcapsules of the present application include, but are not limited to, vitamin A, vitamin D, vitamin E, and vitamin K, and derivatives thereof.

In some embodiments, the one or more hydrophobic agents comprise a flavoring agent(s). As used herein, the term “flavoring agent” refers to agents capable of imparting a flavor to, enhancing a flavor in, or modifying the flavor of a consumable material. Flavorings may be chosen from synthetic flavor oils and flavoring aromatics and/or oils, oleoresins and extracts derived from plants, leaves, flowers, fruits, and so forth, and combinations thereof. Suitable flavoring agents include, but are not limited to, flavoring oils such as peppermint oil, spearmint oil, cinnamon oil, oil of wintergreen (methyl salicylate), clove oil, bay oil, anise oil, eucalyptus oil, thyme oil, cedar leaf oil, oil of nutmeg, allspice, oil of sage, mace, oil of bitter almonds, cassia oil, and combinations thereof. Additional suitable flavoring agents may be chosen from artificial, natural, and synthetic fruit flavors such as vanilla, and citrus oils including lemon, orange, lime, grapefruit, and fruit essences including apple, pear, peach, grape, strawberry, raspberry, cherry, plum, pineapple, apricot, and combinations thereof.

In some embodiments, the one or more hydrophobic agents comprise an antioxidant(s). As used herein, the term “antioxidant” refers to compounds that protect from oxidative deterioration. Suitable antioxidants include, but are not limited to, ascorbyl palmitate, lecithin, alpha-tocopherol, mixed tocopherols, tocotrienols, butylated hydroxy toluene, butylated hydroxyanisole, tert-butylhydroquinone, propylgallate, and combinations thereof.

In some embodiments, the one or more hydrophobic agents comprise a drug(s). The drug may be a cannabinoid, nicotine, or a non-steroidal anti-inflammatory drug (NSAID). Suitable cannabinoids include, but are not limited to, cannabichromene, cannabichromenic acid, cannabidiol, cannabidiolic acid, cannabidivarin, cannabigerol, cannabinol propyl variant, cannabicyclol, cannabinol, cannabinol propyl variant, cannabitriol, tetrahydrocannabinol, tetrahydrocannabinolic acid, tetrahydrocannabivarin, and tetrahydrocannabivarinic acid. Suitable NSAID drugs include, but are not limited to, acetylsalicylic acid, ibuprophen, acetaminophen, diclofenac, indomethacin, piroxicam, and combinations thereof.

Additional suitable drugs include, without limitation, steroids, respiratory agents, sympathomimetics, local anesthetics, antimicrobial agents, antiviral agents, antifungal agents, antihelminthic agents, insecticides, antihypertensive agents, antihypertensive diuretics, cardiotonics, coronary vasodilators, vasoconstrictors, β-blockers, antiarrhythmic agents, calcium antagonists, anti-convulsants, agents for dizziness, tranquilizers, antipsychotics, muscle relaxants, drugs for Parkinson's disease, respiratory agents, hormones, non-steroidal hormones, antihormones, vitamins, antitumor agents, miotics, herb medicines, herb extracts, antimuscarinics, interferons, immunokines, cytokines, muscarinic cholinergic blocking agents, mydriatics, psychic energizers, humoral agents, antispasmodics, antidepressant drugs, anti-diabetics, anorectic drugs, anti-allergenics, decongestants, expectorants, antipyretics, antimigrane, anti-malarials, anti-ulcerative, anti-estrogen, anti-hormone agents, anesthetic agent, or drugs having an action on the central nervous system as described in U.S. Patent Application Serial No. 2016/0000886 to Parker et al., which is hereby incorporated by reference in its entirety.

In some embodiments, the one or more hydrophobic agents comprise an imaging agent(s). As used herein, the term “imaging agent” refers generically an agent useful for any imaging modality. Suitable imaging agents include, but are not limited to, hydrophobic fluorescent dyes, fluorescent probes, pyrene, carbon dots, quantum dots, halogenated triglycerides, such as iodinated or fluorinated triglycerides; perfluorinated lower alkyls; or aliphatic esters of conventional water-soluble contrast agents, such as aliphatic esters of iopanoic acid, which agents may contain a stable or radioactive isotope of the halogen. Suitable hydrophobic fluorescent probes include, e.g., Cy3, Rhodamine Red C2, Atto 647N, and Nile Red (Zanetti-Domingues et al., “Hydrophobic Fluorescent Probes Introduce Artifacts into Single Molecule Tracking Experiments Due to Non-Specific Binding,” PLoS One 8(9):e74200 (2013) and Fowler et al., “Application of Nile Red, a Fluorescent Hydrophobic Probe, for the Detection of Neutral Lipid Deposits in Tissue Sections: Comparison with Oil Red O,” J. Histochem. Cytochem. 33(8):833-836, each of which is hereby incorporated by reference in its entirety.) Additional suitable imaging agents are described in U.S. Pat. No. 5,716,597, International Patent Application Publication No. WO1998046275 A2, and Molecular Imaging and Contrast Agent Database [Internet]. Bethesda (Md.): National Center for Biotechnology Information (2004-2013), each of which is hereby incorporated by reference in its entirety.

In some embodiments, the one or more hydrophobic agents comprise a coloring agent selected from the group consisting of a carotenoid and 2517oflg Natural Orange Color (paprika oleoresin).

As used herein, the term “carotenoid” refers to a wide variety of red and yellow compounds chemically related to carotene that include those found in plant foods. The carotenoids of the present application may comprise red (capsanthin, capsorubin) and/or yellow (beta-carotene, beta-cryptoxanthin, capsoleutin, violaxanthin, zeaxanthin, antheraxanthin, and cryptoxanthin) carotenoids. The forms of carotenoid useful in the microcapsules of the present application include naturally occurring carotenes derived from palm, algal, and fungal sources, for example, Elaiesguineensis JACQ., Dunaliella salina, and Blakeslea trispora. Such naturally occurring materials may be extracted on a commercial scale. In some embodiments, the coloring agent is a carotenoid selected from the group consisting of bixin, beta-carotene, alpha-carotene, gamma-carotene, zeaxanthin, lutein, capsanthin, capsorubin, cryptocapsin, and combinations thereof.

As used herein, the term “oleoresin” refers to semi-solid extracts comprising a resin in solution in an essential and/or fatty oil, obtained by means of a solvent, supercritical fluid, or mechanical processes. The term “paprika oleoresin” refers to an oil-soluble extract from the fruits of Capsicum annuum or Capsicum frutescens. Paprika oleoresin may comprise capsanthin, capsorubin, and/or beta-carotene.

The gel matrix may comprise a “phase change” fluid that can change phases, e.g., from a liquid to a gel. A phase change can be initiated by a temperature change or a change in ionic strength. In some embodiments, the phase change is reversible. For example, a wax or gel may be used at a temperature which maintains the wax or gel as a fluid. Upon cooling, the wax or gel may form a solid, semisolid, or gel, e.g., resulting in a gel matrix. In some embodiments, the gelatin matrix comprises a gel which undergoes setting as a result of a change in temperature or ionic strength. Exemplary gel matrices are described herein below.

The gel matrix may comprise one or more monomers, polymers, and/or co-polymers. In some embodiments, the gel matrix comprises one or more hydrophilic colloids. As used herein, the term “hydrophilic colloid” or “hydrocolloid” refers to naturally occurring gums and synthetic polymers such as polysaccharides (for example, acacia, agar, alginic acid, carrageenan, guar gum, karaya gum, and tragacanth), cellulose derivatives (for example, carboxymethylcellulose and carboxypropylcellulose), and synthetic polymers (for example, carbomers, cellulose ethers, and carboxyvinyl polymers). These disperse or swell in water to form colloidal solutions that stabilize emulsions by forming strong interfacial films around the dispersed-phase droplets and by increasing the viscosity of the external phase. Thus, the gel matrix may comprise a polymer selected from the group consisting of alginate, pectin, κ-carrageenan, gelatin, gellan, agar, alginate/calcium, and combinations thereof. In some embodiments, the polymer is κ-carrageenan.

In some embodiments, the core further comprises a hydrophilic non-ionic surfactant. Suitable non-ionic surfactants include, but are not limited to, sorbitan monooleate (also referred to as Span 80), poly(ethylene glycol)-block-poly(propylene glycol)-block-poly(ethylene glycol), polypropylene glycol)-block-poly(ethylene glycol)-block-poly(propylene glycol) (also referred to as F 108); polyvinyl alcohol (PVA), cetyl alcohol, stearyl alcohol, cetostearyl alcohol (e.g., consisting predominantly of cetyl and stearyl alcohols), oleyl alcohol, polyoxyethylene glycol alkyl ethers (Brij), octaethylene glycol monododecyl ether, pentaethylene glycol monododecyl ether, polyoxypropylene glycol alkyl ethers, glucoside alkyl ethers, decyl glucoside, lauryl glucoside, octyl glucoside, polyoxyethylene glycol octylphenol ethers, triton X-100, polyoxyethylene glycol alkylphenol ethers, nonoxynol-9, glycerol alkyl esters, glyceryl laurate, polyoxyethylene glycol sorbitan alkyl esters, polysorbates (e.g., Tween 20), sorbitan alkyl esters, cocamide MEA, cocamide DEA, dodecyldimethylamine oxide, block copolymers of polyethylene glycol, polypropylene glycol, poloxamers, and combinations thereof. In some embodiments, the hydrophilic non-ionic surfactant is Tween 20.

The enzymatically-cleavable lipid layer may comprise one or more types of lipids, which can be either synthetic, naturally occurring, or a combination of both. Exemplary lipids include, but are not limited to, lauric acid, myristic acid, palmitic acid, stearic acid, arachidic acid, palmitoleic acid, oleic acid, linoleic acid, linolenic acid, arachidonic acid, spermaceti, beeswax, carnauba wax, glycerol monooleate, glycerol monostearate, palm oil, cocoa butter, coconut oil, vegetable oils, and combinations thereof.

The enzymatically-cleavable lipid layer may further comprise an emulsifier. Suitable emulsifiers include, but are not limited to, lecithin (e.g., soy lecithin or egg lecithin), calcium stearoyl di laciate, polyglycerol ester, sorbitan ester, propylene glycol ester, sugar ester, monoglyceride, acetylated monoglyceride, lactylated monoglyceride, glycerol monooleate, glycerol monostearate, and combinations thereof.

Thus, the enzymatically-cleavable lipid layer may be made from a material selected from the group consisting of glycerol monooleate, glycerol monostearate, palmitic acid, beeswax, olieic acid, lecithin, calcium stearoyl di lactylate, polyglycerol ester, sorbitan ester, propylene glycol ester, sugar ester, monoglyceride, acetylated monoglyceride, lactylated monoglyceride, and combinations thereof.

In some embodiments, the enzymatically-cleavable lipid layer is made from a material selected from the group consisting of beeswax/oleic acid, beeswax/stearic acid, beeswax/palmitic acid/lecithin, beeswax/lecithin, and combinations thereof.

The polymer shell may be made from any polymeric material, including a material selected from the group consisting of homopolymers, co-polymers, polypeptides, polysaccharides, and combinations thereof.

In some embodiments, the polymer shell comprises casein and a poloxamer or a polysaccharide.

Casein is the collective name for a family of secreted calcium (phosphate) binding phosphoproteins found in mammalian milk. In bovine milk, casein comprises four peptides: αS1, αS2, β, and κ, differing in their amino acid, phosphorus and carbohydrate content but similar in their amphiphilic character. Hydrophilic and hydrophobic regions of casein show block distribution in the protein chain. Casein peptides carry negative charge on their surface and tend to bind nanoclusters of amorphous calcium phosphate. Caseins are insoluble and account for 80% of total bovine milk proteins. In suitable conditions, casein molecules agglomerate into spherical micelles. Casein micelles exhibit pH-dependent behavior, tightening as the pH drops and swelling with increase of pH. The zeta potential measured for casein micelles has been found to be −8 mV at neutral pH and close to 0 mV on decreasing the pH (Glab et al, “Potential of Casein as a Carrier for Biologically Active Agents,” Top Curr. Chem. 375(4):71 (2017), which is hereby incorporated by reference in its entirety). Industrial manufacture of casein involves a coagulation process that can be carried out by enzymatically (e.g., cleavage of κ-casein by chymosin, a component of rennet) or by acid gelation/precipitation (e.g., lowering the pH to pI (4.6) using mineral or organic acids), as in cheese-making. In some embodiments, the casein is selected from the group consisting of αS1-casein, αS2-casein, β-casein, κ-casein, or combinations thereof.

Caseins may interact with polysaccharides to form complexes that improve stability (Manab, A., “Casein Polysaccharide Interaction—A Review,” Int. J. Chem. Tech. Res. 10(5):1-9 (2017), which is hereby incorporated by reference in its entirety). In some embodiments, the polysaccharide is selected from the group consisting of maltodextrin, pectin, carboxymethylcellulose, dextran, chitosan, acacia (gum Arabic), agar-agar, ammonium alginate, calcium alginate, carob bean gum (Locust bean gum), ghondrus extract (Carrageenan), ghatti gum, guar gum, potassium alginate, sodium alginate, sterculia gum (Karaya gum), tragacanth (gum tragacanth), and combinations thereof.

As used herein, a “poloxamer” is a nonionic triblock copolymer composed of a central hydrophobic chain of polyoxypropylene(poly(propylene oxide)) flanked by two hydrophilic chains of polyoxyethylene(poly(ethylene oxide)). Suitable poloxamers include, but are not limited to, poloxamer 124 (Pluronic® L-44), poloxamer 188 (Pluronic® F-68), poloxamer 237 (Pluronic® F-87), poloxamer 338 (Pluronic® F-108), poloxamer 407 (Pluronic® F-127), poloxamer 401 (Pluronic® L121), poloxamer 184 (Pluronic® L-64), and combinations thereof. In one embodiment, the poloxamer is poloxamer 338 (Pluronic® F-108). Thus, in some embodiments, the polymer shell comprises casein and poloxamer 338 (Pluronic® F-108).

The polymer shell may further comprise a cross-linking agent. In some embodiments, the cross-linking agent is selected from the group consisting of one or more salts, enzymes, and combinations thereof. Suitable salts include, but are not limited to, MgCl₂, CaCl₂, Ca₃(PO₄)₂, and combinations thereof. Suitable cross-linking agents include, but are not limited to, one or more enzymes selected from the group consisting of laccase, transglutaminase, sortase, peroxidase, tyrosinase, transferase, subtilisin, oxidoreductase, and combinations thereof.

Another aspect of the present application relates to a method of preparing a microcapsule. This method involves dispersing one or more hydrophobic agents into an aqueous solution of a hydrophilic non-ionic surfactant and a gel matrix to produce an oil-in-water (o/w) single emulsion; mixing the o/w single emulsion with one or more lipids to produce an oil-in-water-in-oil (o/w/o) double emulsion; blending the o/w/o double emulsion with a secondary aqueous solution to produce an oil-in-water-in-oil-in-water (o/w/o/w) triple microemulsion; drying the o/w/o/w triple microemulsion to form a dried triple microemulsion; and incubating the dried triple microemulsion to form microcapsules each comprising one or more hydrophobic agents in a hydrophilic aqueous core surrounded by a proteolytically-cleavable outer polymer shell with an enzymatically-cleavable lipid layer between said core and said shell.

Suitable hydrophobic agents are described in detail above and include, e.g., coloring agents, vitamins, flavoring agents, antioxidants, drugs, imaging agents, and combinations thereof. In some embodiments, the one or more hydrophobic agents are a coloring agent selected from the group consisting of a carotenoid and 2517oflg Natural Orange Color (paprika oleoresin). In some embodiments, the coloring agent is a carotenoid selected from the group consisting of bixin, beta-carotene, alpha-carotene, gamma-carotene, zeaxanthin, lutein, and combinations thereof.

Suitable hydrophilic non-ionic surfactants and gel matrices are described in detail above. In some embodiments, the hydrophilic non-ionic surfactant is selected from the group consisting of Triton X-100, sorbitan monostearate, tween, and stearyl alcohols. In some embodiments, the gel matrix comprises a gel which undergoes setting as a result of a change in temperature or ionic strength. Accordingly, the gel matrix may comprise a polymer selected from the group consisting of alginate, pectin, κ-carrageenan, gelatin, gellan, agar, alginate/calcium, and combinations thereof. In some embodiments, the polymer is κ-carrageenan.

As used herein, an “emulsion” is a fluidic state which exists when a first fluid is dispersed in the form of droplets in a second fluid that is typically immiscible or substantially immiscible with the first fluid. Examples of common emulsions are oil in water (o/w) and water in oil (w/o) emulsions.

“Multiple emulsions” are emulsions that are formed with more than two fluids, or two or more fluids arranged in a more complex manner than a typical two-fluid emulsion. For example, a multiple emulsion may be oil-in-water-in-oil (o/w/o), or water-in-oil-in-water (w/o/w). A multiple emulsion typically comprises larger droplets that contain one or more smaller droplets therein. The larger droplet or droplets may be suspended in a third fluid in some cases. In some embodiments, emulsion degrees of nesting within the multiple emulsion are possible. For example, an emulsion may contain droplets containing smaller droplets therein, where at least some of the smaller droplets contain even smaller droplets therein, etc. In some embodiments, one or more of the droplets (e.g., an inner droplet and/or an outer droplet) can change form, for instance, to become solidified to form a microcapsule, a liposome, a polymerosome, or a colloidosome.

As described herein, multiple emulsions can be formed to comprise one, two, three, or more inner droplets within a single outer droplet (which droplets may all be nested in some cases). As used herein, the term “fluid” generally means a material in a liquid or gaseous state. Fluids, however, may also contain solids, such as suspended or colloidal particles.

As used herein, two fluids are immiscible, or not miscible, with each other when one is not soluble in the other to a level of at least 10% by weight at the temperature and under the conditions at which the multiple emulsion is produced. For instance, the fluid and the liquid may be selected to be immiscible within the time frame of the formation of the fluidic droplets. In some embodiments, the inner and outer fluids are compatible, or miscible, while the middle fluid is incompatible or immiscible with each of the inner and outer fluids. In other embodiments, however, all three fluids may be mutually immiscible, and in certain cases, all of the fluids do not all necessarily have to be water soluble. In still other embodiments, additional fourth, fifth, sixth, etc. fluids may be added to produce increasingly complex droplets within droplets, e.g., a first fluid may be surrounded by a second fluid, which may in turn be surrounded by a third fluid, which in turn may be surrounded by a fourth fluid, etc.

Suitable lipids are described in detail above and include, e.g., glycerol monooleate, glycerol monostearate, palmitic acid, beeswax, oleic acid, stearic acid, and combinations thereof. Thus, in some embodiments, the enzymatically-cleavable lipid layer is made from one or more lipids selected from the group consisting of beeswax/oleic acid, beeswax/stearic acid, beeswax/palmitic acid, and combinations thereof.

In some embodiments, the o/w single emulsion is mixed with one or more lipids at the melting point of the one or more lipids. Exemplary lipid melting points are shown in Table 1 below.

TABLE 1
Exemplary Lipid Melting Points

| | | Melting | |
|---|---|---|---|
| Lipid | Chemical Formula | Point | |
| Lauric acid | CH₃(CH₂)₁₀CO₂H | 45° | C. |
| Myristic acid | CH₃(CH₂)₁₂CO₂H | 55° | C. |
| Palmitic acid | CH₃(CH₂)₁₄CO₂H | 63° | C. |
| Stearic acid | CH₃(CH₂)₁₆CO₂H | 69° | C. |
| Arachidic acid | CH₃(CH₂)₁₈CO₂H | 76° | C. |
| Palmitoleic acid | CH₃(CH₂)₅CH═CH(CH₂)₇CO2H | 0° | C. |
| Oleic acid | CH3(CH2)7CH═CH(CH2)7CO2H | 13° | C. |
| Linoleic acid | CH3(CH2)4CH═CHCH2CH═CH(CH2)7CO2H | −5° | C. |
| Linolenic acid | CH₃CH₂CH═CHCH₂CH═CHCH₂CH═CH(CH₂)₇CO₂H | −11° | C. |
| Arachidonic acid | CH₃(CH₂)₄(CH═CHCH₂)₄(CH₂)₂CO₂H | −49° | C. |
| Beeswax | CH₃(CH₂)₂4CO₂—(CH₂)₂₉CH₃ | 62-64° | C. |
| Glycerol | C₂₁H₄₀O₄ | 25° | C. |
| monooleate | | | |
| Glycerol | C₂₁H₄₂O₄ | 78-81° | C. |
| monostearate | | | |

In some embodiments, the one or more lipids are solidified at ambient temperature (i.e., cooled to below the melting point of the one or more lipids) to form the enzymatically-cleavable lipid layer.

As described in detail above, the one or more lipids may be mixed with one or more stabilizers selected from the group consisting of lecithin, calcium stearoyl di lactylate, polyglycerol ester, sorbitan ester, propylene glycol ester, sugar ester, monoglyceride, acetylated monoglyceride, lactylated monoglyceride, and combinations thereof. Thus, in some embodiments, the one or more lipids comprises a first lipid and a second lipid, where (i) the first lipid and second lipid are mixed with a stabilizer in a 0.1/10/0.1 to 10/0.1/2 ratio of the first lipid:the second lipid:the stabilizer and (ii) the o/w single emulsion is added to the mixture of one or more lipids at 20° C. to 90° C.

In some embodiments, the o/w/o double emulsion to the secondary aqueous solution ratio during said blending is 1:100 to 70:100.

Suitable stabilizers are described in detail above. In some embodiments, the secondary aqueous solution may be selected from the group consisting of one or more stabilizers selected from the group consisting of co-polymers, polypeptides, polysaccharides, and combinations thereof. Thus, in some embodiments, the secondary aqueous solution comprises casein and a poloxamer. The poloxamer may be poloxamer 338 (Pluronic® F-108). In some embodiments, the secondary aqueous solution comprises casein and a polysaccharide. The polysaccharide may be selected from the group consisting of maltodextrin, pectin, and combinations thereof.

As described herein above, the secondary aqueous solution may further comprise a cross-linking agent. Suitable cross linking agents include, e.g., salts, enzymes, and combinations thereof. The cross-linking agent may comprise one or more salts selected from the group consisting of MgCl₂, CaCl₂, Ca₃(PO₄)₂, and combinations thereof. In some embodiments, the cross-linking agents are one or more enzymes selected from the group consisting of laccase, transglutaminase, sortase, peroxidase, tyrosinase, transferase, subtilisin, oxidoreductase, and combinations thereof.

Blending the o/w/o double emulsion with the secondary aqueous solution may be carried out using a high-shear homogenizer, high-pressure homogenizer, microfluidics, dispersion, mixing, membrane emulsification, and ultrasonication.

In some embodiments, at least a portion of the triple microemulsion is solidified to form a microcapsule. A fluid can be solidified using any suitable method. For example, in some embodiments, the single emulsion, double emulsion, and/or triple emulsion is dried, gelled, and/or polymerized, and/or otherwise solidified, e.g., to form a solid, or at least a semi-solid. The solid that is formed may be rigid, elastic, rubbery, or deformable.

In some embodiments, triple emulsion may be dried to form a solid outer polymer shell containing hydrophilic aqueous core surrounded by an enzymatically-cleavable lipid layer. Any technique able to solidify at least a portion of the triple microemulsion may be used. In some embodiments, a fluid within the secondary aqueous solution of the triple microemulsion may be removed to leave behind one or more polymers capable of forming a solid shell. In other embodiments, the triple microemulsion is cooled to a temperature below the melting point or glass transition temperature of a fluid within the triple microemulsion, a chemical reaction may be induced that causes at least a portion of the triple microemulsion to solidify (for example, a polymerization reaction, a reaction between two fluids that produces a solid product, etc.), or the like. Other examples include pH-responsive or molecular-recognizable polymers, e.g., materials that gel upon exposure to a certain pH, or to a certain species.

In some embodiments, it may be desirable to control the temperature at which the triple microemulsion is dried. For example, in some such embodiments in which polymer shells are formed by drying a triple microemulsions, controlling the drying temperature can ensure that the shell is configured so that it does not rupture during the drying process. In some embodiments, the triple microemulsion may be dried at a temperature in the range of about 25-100° C., 40-80° C., 50-70° C., 50-65° C., 55-65° C., or 50-60° C.

In some embodiments, drying the o/w/o/w triple microemulsion is carried out with conventional methods including, e.g., spray cooling, spray drying, modified spray drying, or sheet drying. For example, drying the o/w/o/w triple microemulsion may be carried out at an outlet temperature of 40-60° C., an inlet temperature of 100-200° C., and a flow rate of 1-10 L/h.

In some embodiments, the present application relates to the microcapsule produced by any of the methods described herein. Thus, in some embodiments, the microcapsules are 1-1,000 μM in diameter, 1-100 μM in diameter, 1-100 μM in diameter, or 2-9 μM in diameter.

A further aspect of the present application relates to a method of selectively coloring cheese curd. This method involves adding a plurality of microcapsules according to the present application to milk to produce a mixture, wherein the plurality of microcapsules comprise one or more hydrophobic coloring agents; acidifying the mixture; coagulating the acidified mixture to generate a curd fraction and a whey fraction; separating the curd fraction from the whey fraction; and ripening the curd to obtain a colored cheese curd.

In some embodiments, the method may further involve drying the separated whey fraction to obtain an uncolored whey powder. For example, the whey fraction may be dried, frozen, and/or freeze dried.

Freezing of the whey fraction may be carried out by placing the whey fraction in a freeze-drying flask and rotating the flask in a bath, also known as a shell freezer, which is cooled by, for example, mechanical refrigeration, by a mixture of dry ice with an alcohol such as methanol or ethanol, or by liquid nitrogen. Alternatively, freezing may be carried out using a commercially available freeze-drying apparatus or a temperature controlled freeze-drying machine. The whey fraction may be rapidly frozen in order to avoid the formation of ice crystals. Freezing temperatures may range between −50° C. and −80° C.

Drying the whey fraction may be carried out by lowering the pressure using a vacuum (typically to the range of a few millibars) and applying sufficient heat to the material for any water in the whey fraction to sublimate.

Suitable hydrophobic coloring agents are described in detail above and include, e.g., carotenoids and 2517oflg Natural Orange Color (paprika oleoresin). In some embodiments, the carotenoid is selected from the group consisting of bixin, beta-carotene, alpha-carotene, gamma-carotene, zeaxanthin, lutein, and combinations thereof.

Acidifying the mixture can be carried out microbially or directly, or by a combination of both microbial and direct acidification. Microbial acidification is carried out by the addition of a starter culture of one or more lactic acid-producing bacteria to the milk, and then allowing the bacteria to grow and multiply. Thus in some embodiments, acidifying the mixture is carried out by addition of a bacterial starter culture to the mixture.

Direct acidification is carried out using an acid. Thus, in some embodiments, acidifying the mixture is carried out by addition to the mixture of an acid selected from the group consisting of organic acids and dry organic salts. Suitable acids include, e.g., acetic acid, phosphoric acid, citric acid, lactic acid, hydrochloric acid, sulfuric acid, glucono-delta lactone (GdL), lactobionic acid, and combinations thereof.

During coagulation of the acidified mixture, modifications to the milk protein complex occur under defined conditions of temperature and by action of a coagulant agent, which changes the physical aspect of milk from liquid to a jelly-like mass. Various coagulants are available, e.g. lemon juice, plant rennet, or more commonly a proteolytic enzyme such as chymosin (rennin) or—due to high demand from the cheese industry—proteolytic enzymes from the mould Rhizomucor miehei obtained via biotechnology. These enzymes have an acidic nature, meaning that they have optimum activity in a slightly acidic environment. Thus, in some embodiments, coagulating the acidified mixture is carried out by adding rennet to the mixture. In other embodiments, coagulating the acidified mixture is carried out by heating the acidified mixture to 25-65° C. for 10-360 minutes.

Separating the curd fraction from the whey fraction may be carried out by centrifugation, straining, filtering, or combinations thereof.

As described in detail above, the microcapsules may further comprise one or more vitamins, flavoring agents, antioxidants, drugs, and combinations thereof.

In some embodiments, the present application relates to the colored cheese curd prepared by the methods described herein. In other embodiments, the present application relates to the uncolored whey powder prepared by the methods described herein.

Another method of the present application relates to a method of selectively delivering a hydrophobic agent to a food product. This method involves providing a food product; adding a plurality of microcapsules according to the present application to the food product to produce a mixture; and exposing the mixture to proteolytic and enzymatic conditions to produce a modified food product treated with the one or more hydrophobic agents.

Suitable food products include, but are not limited to, dairy products, meat products, pastry products, snack products, and bakery products. For example, suitable food products include cheese, yogurts, milk, sour cream, buttermilk, milkshakes, dips, sausages, ham, salami, pastrami, pepperoni, puff pastry, flaky pastry, crust pastry, chips, crackers, popcorn, pretzels, bread, cakes, and cheesecake.

In some embodiments, the one or more hydrophobic agents is selected from the group consisting of one or more natural or synthetic coloring agents, vitamins, flavoring agents, antioxidants, drugs, imaging agents, and combinations thereof. Suitable hydrophobic agents are described in detail above. Thus, in some embodiments, the one or more hydrophobic agents is a carotenoid selected from the group consisting of bixin, beta-carotene, alpha-carotene, gamma-carotene, zeaxanthin, lutein, and combinations thereof.

In some embodiments, exposing the mixture to proteolytic and enzymatic conditions is carried out by addition of a bacterial starter culture to the mixture. Suitable bacterial starter cultures are described in detail above.

In other embodiments, exposing the mixture is carried out by addition of an acid selected from the group consisting of organic acids and dry organic acid salts, to the mixture. Suitable acids are described in detail above.

Yet another aspect of the present application relates to a method of treating a subject with one or more hydrophobic agents. This method involves selecting a subject in need of treatment and administering a plurality of microcapsules according to the present application to the selected subject, wherein the plurality of microcapsules are subjected to proteolytic and enzymatic conditions, thereby releasing the one or more hydrophobic agents in the subject.

In some embodiments, the subject is a mammalian subject, for example, a human subject. Suitable human subjects include, without limitation, children, adults, and elderly subjects.

The subject may also be non-human, such as bovine, ovine, porcine, feline, equine, murine, canine, lapine, etc.

In some embodiments, the subject is in need of treatment for a vitamin deficiency. For example, the subject may be in need of treatment for decreased levels of vitamin A, vitamin D, vitamin E, and/or vitamin K.

In some embodiments, the subject is in need of treatment for a disease. For example, the subject may be in need of treatment for a cancer. The subject may be in need of a drug for the treatment of the cancer or an imaging agent to diagnose the cancer or to measure the effectiveness of a treatment for the cancer.

In some embodiments, the hydrophobic agent is selected from the group consisting of vitamins, drugs, imaging agents, and combinations thereof. Suitable vitamins, drugs, and imaging agents are described in detail above.

Administering the microcapsules may be carried out nasally, orally, topically, transdermally, parenterally, subcutaneously, intravenously, intramuscularly, intraperitoneally, by intranasal instillation, by intracavitary or intravesical instillation, intraocularly, intraarterially, intralesionally, or by application to mucous membranes. For example, when microcapsules comprising a vitamin are administered orally to a subject in need of treatment for a vitamin deficiency, the microcapsule shell may protect the microcapsule from releasing the one or more vitamins in the acidic conditions of the stomach to allow delivery of the vitamins to the small intestine, where microcapsule cleavage can occur to release the hydrophobic agent.

In some embodiments, administrating is carried out daily, weekly, biweekly, monthly, semi-annually, annually, or any amount of time there between. In other embodiments, administering is carried out infrequently.

The administering may be sufficient to increase vitamin A, vitamin D, vitamin E, and/or vitamin K levels to within a target range. For example, in some embodiments, the subject may be in need of treatment for a vitamin D deficiency and administering is sufficient to increase serum vitamin D levels to 20-50 ng/ml.

In some embodiments, the proteolytically-cleavable outer polymer shell and the enzymatically-cleavable lipid layer are composed of materials which selectively release the one or more hydrophobic agents at a particular site within the subject. Thus, the administering may be sufficient for targeted delivery of a drug. For example, human hepatic lipase overexpression, which induces hepatic steatosis and obesity, can be assigned as a target to deliver a specific drug and control its release by the microcapsules of the present application.

### EXAMPLES

The following examples are provided to illustrate embodiments of the present invention but are by no means intended to limit its scope.

### Materials and Methods for Examples 1-5

### Materials

Oil-soluble bixin was provided by Chr. Hansen Laboratory A/S, Denmark. Beeswax was donated by Strahl & Pitsch Inc. (West Babylon, N.Y., US). Soy lecithin was donated by ADM (Decatur, Ill., US). κ-Carrageenan was provided by Tic Gums, Inc. (Belcam, Md., US). Lipase (˜150,000 FIP/g) was donated by Mak Wood Inc. (Grafton, Wis., US). Triton X-100 was purchased from Fisher Scientific (Nepean, ON, Canada). Sodium caseinate and Poloxamer 338 (Pluronic® F108) were purchased from Sigma-Aldrich (St. Louis, Mo., US).

### Preparation of Color-Loaded Microcapsules

Microcapsules were prepared using a microemulsion dilution method. Different formulations were examined to prepare the microcapsules (Table 2), and the

TABLE 2
Different Formulations for Microcapsule Preparation

| Formulation | Core oil | O/W | Aqueous | | Aqueous | |
|---|---|---|---|---|---|---|
| No. | phase | Surfactant | phase | Oil phase | phase | Surfactant |
| 1 | Bixin | — | — | Beeswax | Casein/starch/ | — |
| | | | | | chitosan | |
| 2 | Bixin | Triton X- | κ- | Beeswax | Casein/ | Soy |
| | | 100 | Carrageenan | | poloxamer | lecithin |
| | | | | | 338 | |
| 3 | Bixin | Triton X- | κ- | Carnauba | Casein/ | Soy |
| | | 100 | Carrageenan | wax | poloxamer | lecithin |
| | | | | | 338 | |
| 4 | Bixin | Triton X- | κ- | Beeswax/ | Casein | Soy |
| | | 100 | Carrageenan | palmitic | | lecithin |
| | | | | acid | | |
| 5 | Bixin | Triton X- | κ- | Beeswax/ | Casein/ | Soy |
| | | 100 | Carrageenan | palmitic | poloxamer | lecithin |
| | | | | acid | 338 | |

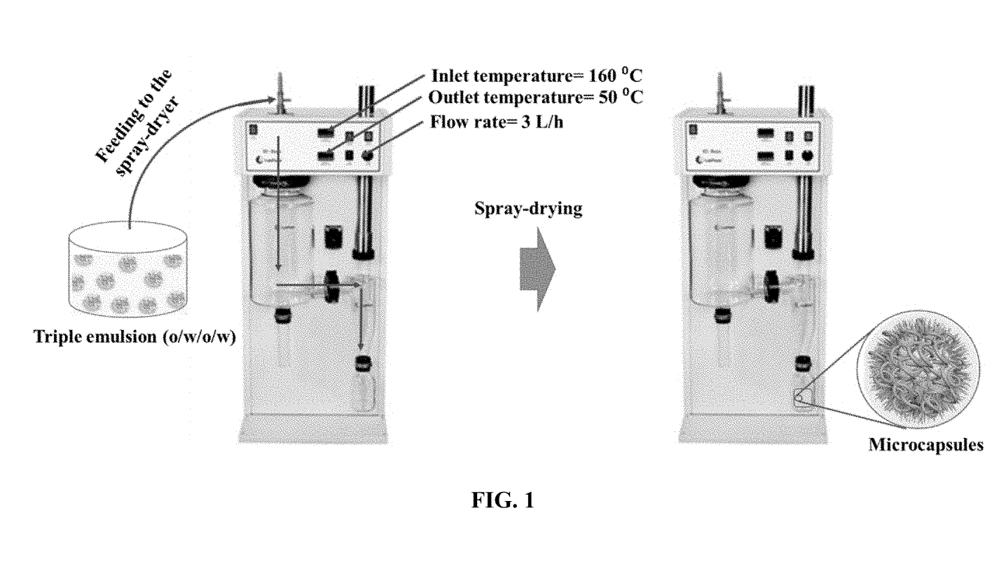

best formulation was selected. The best formulation was prepared in the following manner: briefly, oil-soluble bixin (50%, w/w) was dispersed in an aqueous solution of κ-carrageenan (1%, w/w) and Triton X-100 (10%) under stirring to prepare an oil in water (o/w) single emulsion. This single emulsion was then added dropwise to the lipid oil phase at 64° C. containing a mixture of palmitic acid, beeswax, and soy lecithin (2:1:0.1) under vigorous stirring to prepare an o/w/o microemulsion. This o/w/o double emulsion was dispersed in a secondary aqueous solution (15:100, double emulsion:secondary aqueous solution), containing sodium caseinate (3.3%, w/w) and poloxamer 338 (1%, w/w) using a high-shear homogenizer (VWR 200 Homogenizer Unit, Randor, Pa., USA) at 15000 rpm for 5 minutes in an ice bath (3° C.). This o/w/o/w triple microemulsion was spray-dried at an outlet temperature of 50° C., inlet temperature of 160° C., and flow rate of 3 L/h (Labplant Spray Dryer SD-Basic, Labplant, UK, Ltd. North Yorkshire, UK). The lipid phase was solidified at 3° C. to form a lipid layer. Following the spray-drying step, a polymer layer of casein-poloxamer was formed on top of the lipid layer (FIG. 1).

### Optical Microscopy

Optical images were obtained using an inverted optical microscope (DMIL LED, Leica) connected to a fast camera (MicroLab 3a10, Vision Research).

### Scanning Electron Microscopy

Scanning electron microscopy (SEM) was conducted to characterize the surface morphology of the microcapsules. The samples were mounted on alumina stubs using double adhesive tape and coated with gold for 30 seconds. Then, the samples were observed using a JCM-6000 Benchtop Scanning Electron Microscope, software version 2.4 (JEOL Technics Ltd., Tokyo, Japan).

### Cryo-Scanning Electron Microscopy (Cryo-SEM)

Using cryo-SEM images, the structure of the microcapsules was assessed. Cryo-SEM experiments were performed using a Quorum P3010 system (Qurorum Technologies, Newhaven, UK). The samples were plunge-frozen in liquid nitrogen, transferred under vacuum to the P3010, and coated with gold-palladium for 30 seconds. Samples were maintained at −165° C. in the preparation chamber. The samples were transferred to the focused ion beam (FIB) to take images at −165° C.

### Zeta-Potential

The zeta-potential was determined with a NanoZ S90 zeta-sizer (Malvern 142 Instrument Ltd., UK) with a He/Ne laser (λ=633 nm) at a fixed scattering angle of 90° at 25 (±0.1). The zeta potential values were automatically calculated from the electrophoretic mobility based on the Smouluchowski model (Fukui et al., “The Preparation of Sugar Polymer-Coated Nanocapsules by the Layer-by-Layer Deposition on the Liposome,” Langmuir 25(17):10020-10025 (2009), which is hereby incorporated by reference in its entirety). All measurements were performed in triplicate and reported as averages thereof.

### Size

Images of the samples were obtained using an inverted optical microscope (DMIL LED, Leica) and analyzed with ImageJ (Version 1.4.3.67) to measure the average particle size.

### X-Ray Diffraction

X-ray diffraction (XRD) measurements were performed using a Bruker D8 Advance ECO powder diffractometer (MA, USA). The generator was operated at 40 kV and 30 mA (Cu Ka radiation). Samples were scanned at room temperature from 2θ=2° to 45° under continuous scanning in 0.02 steps of 2θ min⁻¹.

### Encapsulation Efficiency and Release Kinetics

Microcapsules were centrifuged (10 minutes, 4° C., 17000 g) and the non-encapsulated free color was measured in the supernatant. The pellet was dissolved in 1 mL acetone, vortexed, centrifuged (10 minutes, 4° C., 17000 g) and the encapsulated color was measured using UV-VIS spectrophotometry (UV-Vis Spectrophotometer UV-2600, Shimadzu Scientific Instruments/Marlborough, Massachusetts—USA) at a wavelength of 452 nm for bixin. The standard bixin curve was obtained through the color solutions in a concentration gradient, and used to convert absorbance to concentration. The encapsulation efficiency (EE %) was calculated using the following equation:

$$Encapsulation efficiency ( \% ) = \frac{The color in the pellet}{The color in the pellet + The color in the supernatant} * 100$$

In addition, the release of color from the microcapsules was studied in citrate-phosphate buffer with a pH of 6.0, containing lipase (100 mg/ml), protease (50 mg/ml), a combination of lipase (100 mg/ml) and protease (50 mg/ml), and no enzyme (control) at a temperature of 26° C. The released color from the microcapsules was measured in the supernatant using UV-VIS spectrophotometry at different time intervals (0, 3, 8, and 14 days).

### Employing the Microcapsules in the Cheddar Cheese Making Process Simulation of Cheddar Cheese Making Process

The microcapsules (0.01 g) were added to whole milk (20 ml), and the pH was adjusted to 4.6 to precipitate casein. Then, the system was heated to 60° C. for 30 minutes and centrifuged at 15000 g to separate the casein curd from whey proteins in the supernatant. The supernatant was freeze-dried to obtain the white whey, and the curd was transferred to the wells of a 24-well microplate to simulate the ripening step. To simulate the ripening process, the pH of the curd was adjusted to 6.0, then lipase (50 mg) was added to the curd. The curd was then incubated at 26° C. for 14 days.

### Color Measurements of the Colored Cheese

The color of the Cheddar cheese samples was measured using a Chroma Meter CR-400 (Konica Minolta Sensing Inc., Japan) and reported in terms of lightness (L*), red-green (a*), and blue-yellow (b*) (Ravanfar et al., “Postharvest Sour Cherry Quality and Safety Maintenance by Exposure to Hot-Water or Treatment with Fresh Aloe Vera Gel,” J. Food Sci. Technol. 51(10):2872-2876 (2014), which is hereby incorporated by reference in its entirety).

### Fourier Transform Infrared Spectroscopy of the Colored Cheese

The Fourier transform infrared spectroscopy (FTIR) spectra of the microcapsules in the Cheddar cheese were investigated in the region from 4000 to 400 cm⁻¹ (120 scans, resolution of 2 cm⁻¹) using a IRAffinity-1S FTIR spectrophotometer (Shimadzu Scientific Instruments/Marlborough, Mass.—USA).

### Statistical Analysis

Data were subjected to analysis of variance (ANOVA) using SPSS software package version 15.0 for Windows. All measurements were performed in triplicate. Mean comparisons were performed using the Post Hoc Multiple Comparison Duncan test to examine if differences were significant at P<0.05. A two-sample t-test was used to compare the samples that contained microcapsules with the samples without microcapsules (control) at 95% confidence interval using Microsoft Excel.

### Example 1—Design of Enzymatically-Triggered Microcapsules with a Core-Shell Structure

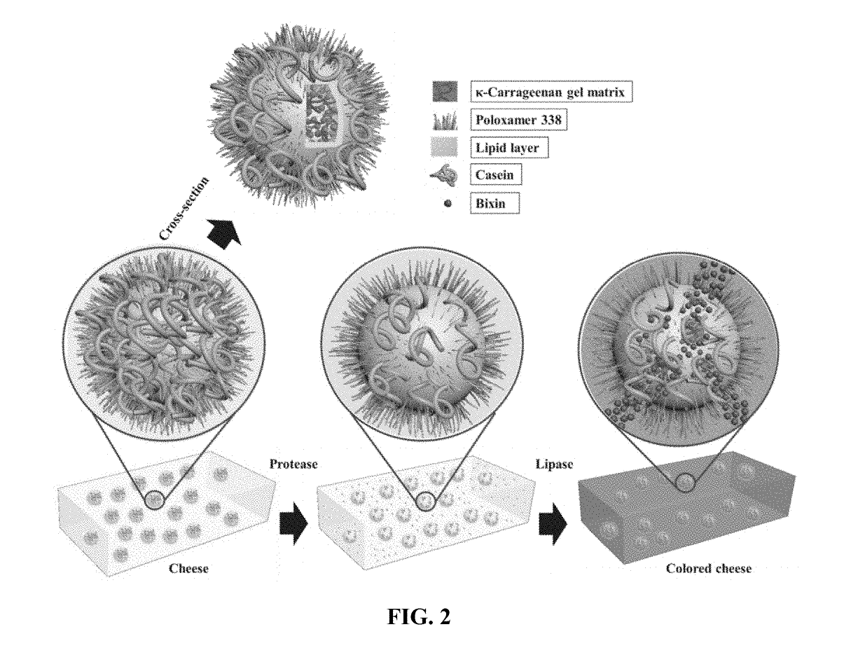

Enzymatically-triggered microcapsules were designed with a core-shell structure. The microcapsule shell contains both a lipid layer (comprising beeswax, palmitic acid, and lecithin) and a polymer layer (comprising casein and poloxamer 338) (FIG. 2). The lipid layer contains ester bonds, which are disintegrated in response to lipase. The lipid layer can be designed using lipids with different numbers of ester bonds and hydrocarbon chain lengths to control their availability to lipase in different biological systems. The polymer layer is engineered according to the environment of the biological system and guarantees the transportation and distribution of microcapsules to the desired site or step in a biological system. The microcapsule core contains a single emulsion of a lipophilic compound—bixin as a model system—in an aqueous solution of κ-carrageenan (FIG. 2). κ-carrageenan contains ester sulfate groups and 3,6-anhydrogalactose (Tecante, A.; Santiago, M. d. C. N., “Solution Properties of κ-Carrageenan and its Interaction With Other Polysaccharides in Aqueous Media,” In Rheology; InTech: (2012), which is hereby incorporated by reference in its entirety) and forms a strong thermo-reversible gel through a coil-helix conformational transition, which may be accompanied by aggregative interactions between the ordered molecules, leading to the formation of an infinite biopolymeric network (Mangione et al., “Thermoreversible Gelation of κ-Carrageenan: Relation Between Conformational Transition and Aggregation,” Biophys. Chem. 104(1):95-105 (2003), which is hereby incorporated by reference in its entirety). The incorporation of κ-carrageenan in the microcapsule core provides a gel matrix at ambient temperature, which prevents the movement of the entrapped bixin molecules due to the high gel viscosity.

### Example 2—Preparation of Enzymatically-Triggered Microcapsules with a Core-Shell Structure

To achieve the desired microcapsule architecture, a triple o₁/w₁/o₂/w₂ microemulsion (where o₁ is the oil solution of bixin, w₁ is κ-carrageenan, o₂ is palmitic acid, beeswax and lecithin, and w₂ is casein and poloxamer 338) was prepared. The lipid phase was solidified at ambient temperature to form the lipid layer of the microcapsule shell (FIG. 2). The casein and poloxamer around the lipid layer formed a polymer layer on top of the lipid layer (FIG. 2) after the spray-drying step. During spray-drying, the outlet temperature was set to 50° C. (below the melting point of beeswax and palmitic acid) to avoid probable bixin leakage from the microcapsules. Therefore, the microcapsule lipid layer remained solid and intact during the spray-drying process, while a layer of casein and poloxamer was deposited on top of the lipid layer.

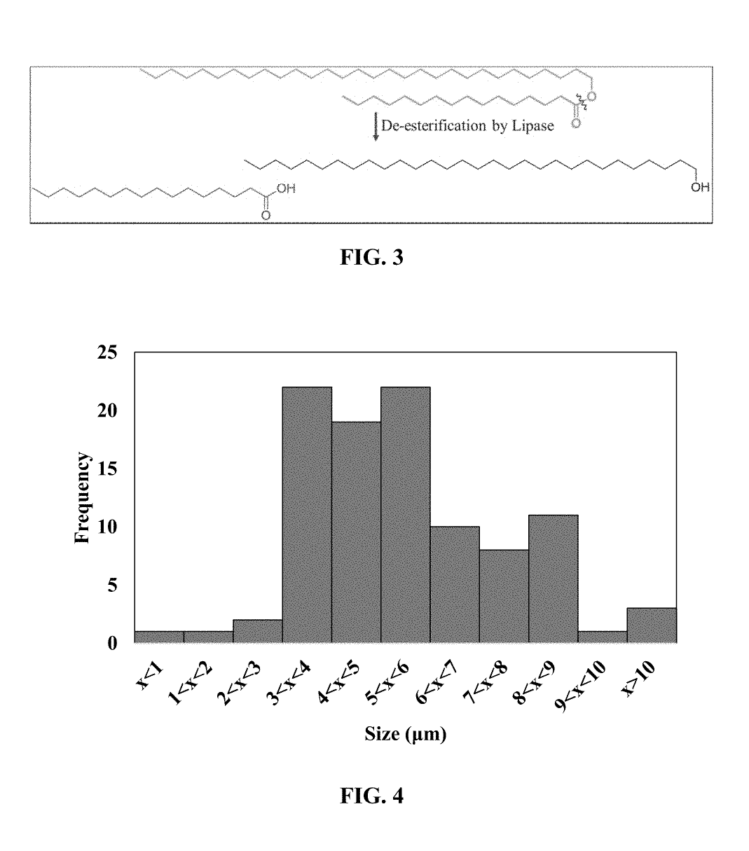

Lipid layer positioning on the amorphous gel matrix resulted in a high encapsulation efficiency (81.8±1.4%) of the microcapsules, as well as protection of the microcapsule architecture against undesired conditions, such as changes in pH, temperature, and ionic strength. Beeswax contains ester bonds in its molecular structure (Wlodawer et al., “Esterification of Fatty Acids in the Wax Moth Haemolymph and its Possible Role in Lipid Transport,” J. Insect Physiol. 12(5):547-560 (1966) and Wang et al., “Quantitative and Discriminative Analysis of Carnauba Waxes by Reactive Pyrolysis-GC in the Presence of Organic Alkali using a Vertical Microfurnace Pyrolyzer,” JAAP 58:525-537 (2001), each of which are hereby incorporated by reference in their entirety), and these ester bonds are broken down by lipase (Hargrove et al., “Nutritional Significance and Metabolism of Very Long Chain Fatty Alcohols and Acids from Dietary Waxes,” Exp. Biol. Med. 229(3):215-226 (2004), which is hereby incorporated by reference in its entirety) into very long chain fatty alcohols and fatty acids. These long chain fatty alcohols decrease plasma cholesterol in humans (Hargrove et al., “Nutritional Significance and Metabolism of Very Long Chain Fatty Alcohols and Acids from Dietary Waxes,” Exp. Biol. Med. 229(3):215-226 (2004), which is hereby incorporated by reference in its entirety). The major component of beeswax is triacontanyl palmitate (Abdikheibari et al., “Beeswax-Colophony Blend: A Novel Green Organic Coating for Protection of Steel Drinking Water Storage Tanks,” Metals 5(3):1645-1664 (2015), which is hereby incorporated by reference in its entirety), which is broken down into palmitic acid and triacontanol by lipase (FIG. 3).

Studies suggest that triacontanol decreases low-density lipoprotein (LDL) cholesterol levels and raises high-density lipoprotein cholesterol levels (Torres et al., “Treatment of Hypercholesterolemia in NIDDM with Policosanol,” Diabetes Care 18(3):393-397 (1995), which is hereby incorporated by reference in its entirety). Thus, using beeswax in the microcapsule shell does not interfere with the safety of the biological system. Besides improving the nutritional value of the biological system, the degradation of beeswax by lipase loosens the microcapsule shell structure and releases its cargo to the system. Recent studies report the use of short peptide sequences as linkers in the structure of liposome, which are cleaved by matrix metalloproteinases (Zhu et al., “Matrix Metalloprotease 2-Responsive Multifunctional Liposomal Nanocarrier for Enhanced Tumor Targeting,” ACS Nano 6(4):3491-3498 (2012) and Harris et al., “Protease-Triggered Unveiling of Bioactive Nanoparticles,” Small 4(9):1307-1312 (2008), each of which are hereby incorporated by reference in their entirety). Similarly, porous silica nanoparticles (Singh et al., “Bioresponsive Mesoporous Silica Nanoparticles for Triggered Drug Release,” JACS 133(49):19582-19585 (2011), which is hereby incorporated by reference in its entirety) or liposomes (Banerjee et al., “Release of Liposomal Contents by Cell-Secreted Matrix Metalloproteinase-9,” Bioconjugate Chemistry 20(7):1332-1339 (2009), which is hereby incorporated by reference in its entirety) with a coating of protease-sensitive polymer are used for triggered release. In the present example, casein and poloxamer 338 formed a polymer layer of the microcapsule shell after the spray-drying step.

The rationale behind emulsifying bixin (oil) in water containing k-carrageenan to prepare the initial single emulsion was to use k-carrageenan as a gelling and protecting agent, which prevents the coalescence and merging of bixin droplets (oil) with the third layer (palmitic acid and beeswax) upon emulsification. Therefore, upon injecting the heated (above the melting point of the wax and the gelling point of the carrageenan) double emulsion o/w/o (bixin/k-carrageenan/beeswax and palmitic acid) into the water continuous phase at 3° C. and applying 15000 rpm, the o/w/o double emulsion breaks up into smaller droplets in a short time, and concurrently the internal phases become solid. This means that within the first couple of seconds k-carrageenan forms a gel and beeswax becomes solid, which prevents merging of the internal bixin oil with the beeswax, and therefore this strategy provides a method to obtain a triple o/w/o/w emulsion with a high yield.

### Example 3—Characterization of Enzymatically-Triggered Microcapsules with a Core-Shell Structure

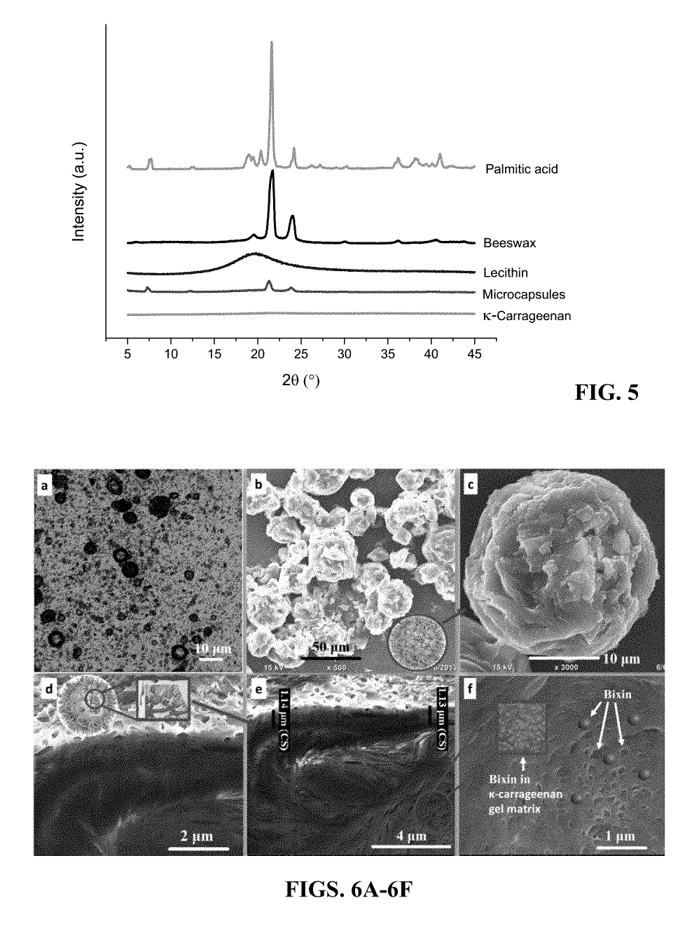

Almost 95% of the resulting microcapsules are in the size range of 3-9 with a zeta potential of −6.8±0.7 mV, which are physicochemically stable in the biological system (FIG. 4). The XRD spectra of the microcapsules and microcapsule shell materials was next investigated (FIG. 5). Pure palmitic acid and beeswax exhibited crystalline structures and sharp peaks, while lecithin showed a broad peak at a lower 20 value. However, the peaks for pure palmitic acid, beeswax, and lecithin did not superimpose completely with those for microcapsules containing a mixture of these materials in their shell. External factors, such as temperature, pressure, and impurity, can strongly influence crystal structure (Chernov, A., “Challenges in Crystal Growth Science and the Microgravity Tool,” Advances in Crystal Growth Research, ed. K. Sato, Y. Furokawa, K. Nakajima, Elsevier, Amsterdam 2001, which is hereby incorporated by reference in its entirety). Therefore, the microcapsules may have a different polymorphism compared with the bulk materials. Moreover, surfactant can also influence the crystal behavior of lipids (Bunjes et al., “Influence of Emulsifiers on the Crystallization of Solid Lipid Nanoparticles,” J. Pharm. Sci. 92(7):1509-1520 (2003), which is hereby incorporated by reference in its entirety). The peaks at 2θ=22° and 24°, corresponding to both palmitic acid and beeswax, the peak at 2θ=18°, corresponding to lecithin, and the peak by long spacing at 2θ=7°, corresponding to pure palmitic acid, were superimposed with those of the microcapsules. Beeswax molecules can be incorporated into the crystal lattice of palmitic acid in the microcapsule shell containing ˜67% palmitic acid. The microcapsules feature a lower crystallinity degree than pure palmitic acid, beeswax, and lecithin. The reduction in the proportion of crystalline to amorphous phases in the microcapsule shell implied a greater amorphous phase content in the microcapsules' shell, which can be positioned on top of the amorphous κ-carrageenan gel matrix in the microcapsule core without any difficulty (FIG. 5).

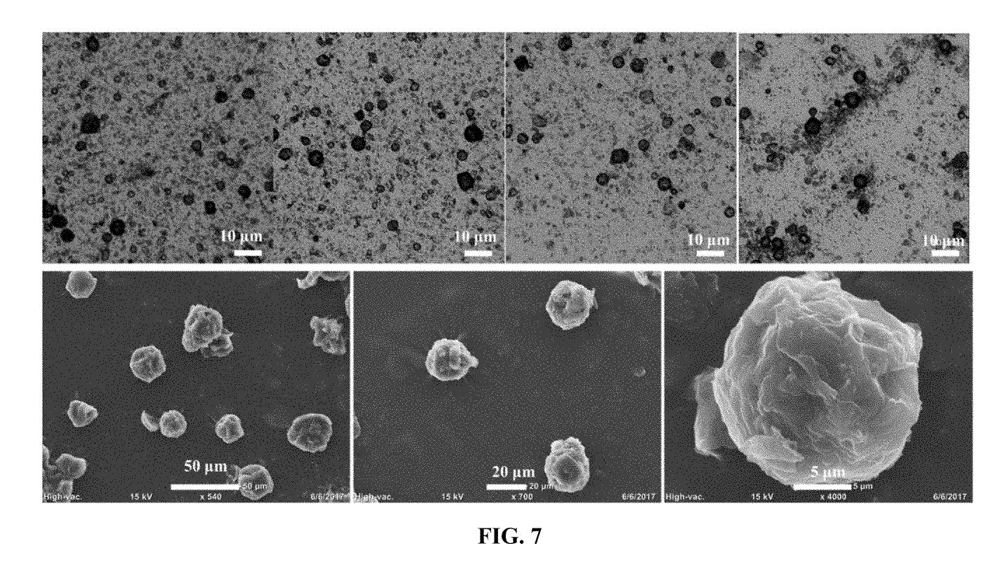

The microcapsules observed using a light microscope exhibited a spherical shape with a lighter shade in the aqueous core and a darker shade in the shell (FIG. 6A), confirming the core-shell structure of the microcapsules. The SEM images of the microcapsules revealed the non-smooth surface of the spherical microcapsules (FIG. 6B and FIG. 6C). This non-smooth and non-uniform surface of the microcapsules is formed due to rapid cooling of the lipid shell, composed of palmitic acid and beeswax, during the homogenization step in the ice-bath. This rapid solidification of the lipids in the microcapsule shell can be ascribed to roughness observed on the surface of the microcapsules, as well as to the large size and high polydispersity of the microcapsules. Other studies have also shown that time and temperature are two main parameters that determine the shape and smoothness of the particles (Wang et al., “Synthesis and Characterization of Microencapsulated Sodium Phosphate Dodecahydrate,” J. Appl. Polym. Sci. 130(3):1516-1523 (2013), which is hereby incorporated by reference in its entirety). FIGS. 6D-6 show the cryo-SEM images of the microcapsules cross-sectioned using a focused ion beam. This structure is attributed to the method used to prepare the microcapsules. The microcapsule shell with a thickness of ˜1 μm surrounds the core of the microcapsules. The swirling patterns observed in the cross-section of the microcapsule core demonstrates the presence of the aqueous gel matrix of κ-carrageenan, which is structurally looser than the solid lipid shell and becomes frozen quickly by liquid nitrogen during the sample preparation for cryo-SEM imaging. The presence of small, dark droplets in this core structure shows the bixin entrapped in the κ-carrageenan gel matrix. Additional images of the microcapsules can be found in FIG. 7.

### Example 4—Encapsulated Cargo Release Kinetics

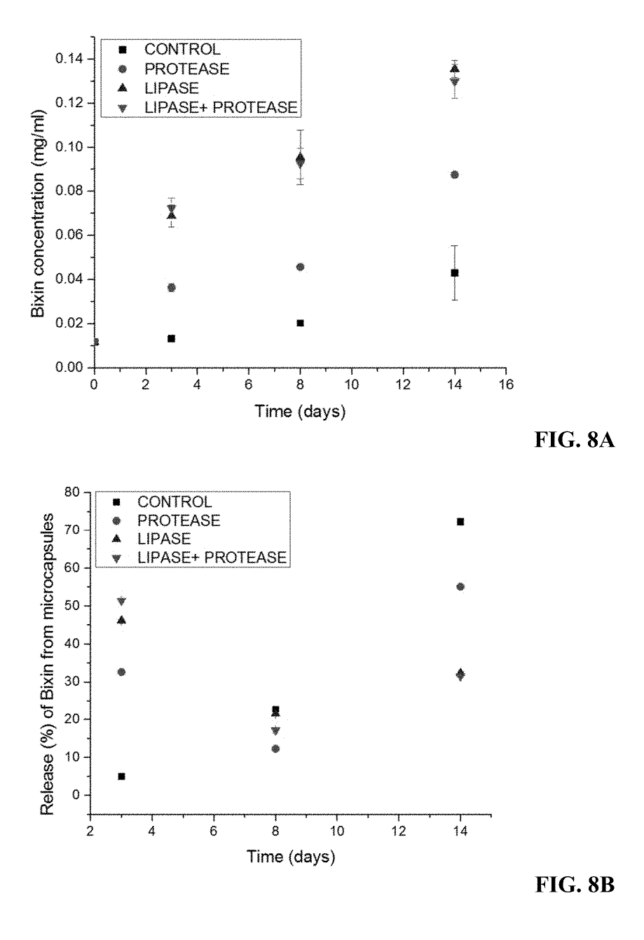

FIGS. 8A-8B shows the release of bixin from the microcapsules when exposed to lipase and protease enzymes. Following exposure, the results show a significant increase in bixin release from the microcapsules exposed to enzymes in comparison with the control (no enzymes; FIG. 8A). The microcapsules exposed to lipase, and a combination of lipase and protease show significantly higher release in comparison with the microcapsules exposed to protease. However, there is no significant difference between the release of bixin from the microcapsules exposed to lipase and those exposed to the combination of lipase and protease. This result indicates the key role of lipase in the disintegration of the microcapsule shell and the resulting bixin release. The release (%) of bixin from the control microcapsules increases over time, while the release (%) from the microcapsules exposed to enzymes shows a different pattern (FIG. 8B). In the first three days of storage, the release (%) from the microcapsules exposed to the combination of lipase and protease is more than the release (%) from the microcapsules exposed to only lipase and only protease, respectively. Between the third to eighth days of storage, however, the release (%) from the microcapsules exposed to enzymes decreases. In the time between the eighth to fourteenth days of storage, the release (%) for the microcapsules exposed to enzymes increases again (FIG. 8B). Thus, the enzymes change the profile of bixin release from the microcapsules and accelerate the release in the first three days of storage (FIG. 8B). A study reports an increase in the released cargo from protease-responsive colloidal mesoporous silica shortly after the addition of trypsin (Schlossbauer et al., “Biotin-Avidin as a Protease-Responsive Cap System for Controlled Guest Release from Colloidal Mesoporous Silica,” Angewandte Chemie 121(17):3138-3141 (2009) hereby incorporated by reference in its entirety). This system is used to close the pore system of colloidal mesoporous silica with the avidin-biotin system, and to release the loaded molecules subsequently by enzymatic hydrolysis of the caps (Schlossbauer et al., “Biotin-Avidin as a Protease-Responsive Cap System for Controlled Guest Release from Colloidal Mesoporous Silica,” Angewandte Chemie 121(17):3138-3141 (2009) hereby incorporated by reference in its entirety).

The release kinetics of the microcapsules can be controlled by internal phase composition, the solid lipid layer composition and the thickness of lipid or polymer layer. For example, the ratio of the beeswax in the lipid layer can be increased to delay the hydrolysis of the lipid layer by lipase. In addition, a decrease in the thickness of the polymer layer (casein) can hasten the degradation of this layer by protease.

### Example 5—The Effect of a Simulated Cheddar Cheese-Making Process on the Encapsulated Cargo

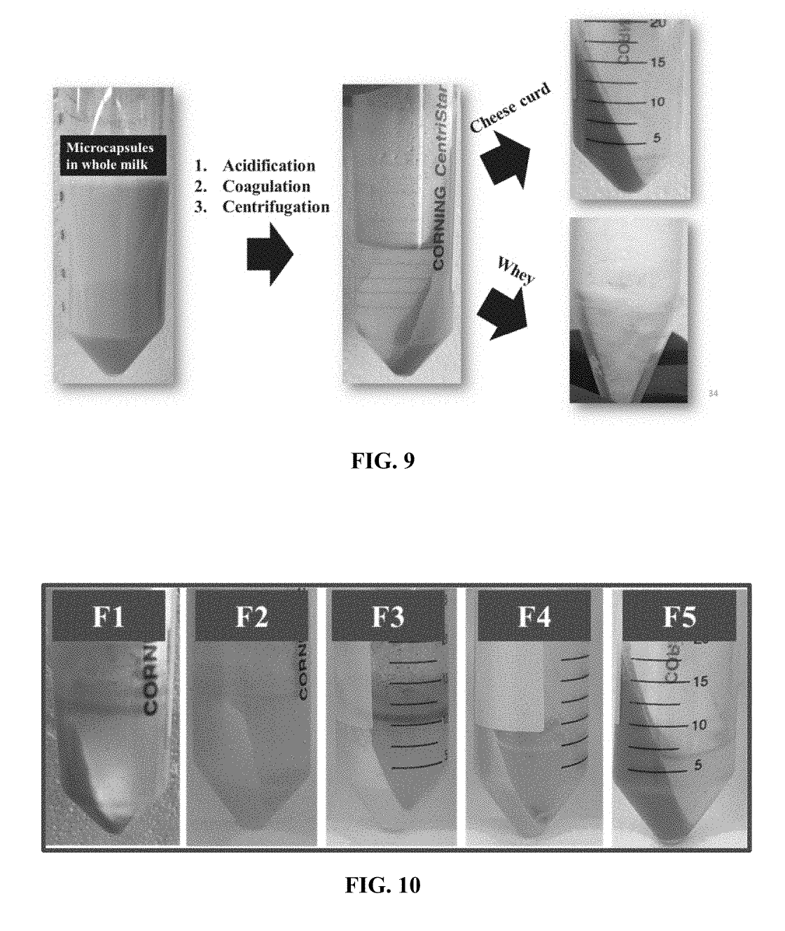

This microcapsule design can be applied in the Cheddar cheese-making process to selectively color the cheese curd matrix. Using this platform, white whey is obtained from the Cheddar cheese making process without the addition of external bleaching agents (FIG. 9). The microcapsules are not affected by the alteration of temperature, ionic strength, or pH of the cheese during the process, and deliver the colorant to the cheese ripening step (FIG. 9). The presence of casein in the polymer layer of the microcapsule shell helps the microcapsules to be coagulated with the other casein molecules in the milk during the coagulation step of cheese making process (FIG. 9).

The casein layer of the microcapsules is degraded through the cheese-making process by endogenous or exogenous proteases in the system, bringing the lipid layer of the microcapsule to the interface, as the microcapsules reach the cheese ripening step. The casein may also increase the yield of the Cheddar cheese, because it is coagulated in the curd along with the other casein molecules. Therefore, microcapsules do not enter the whey, and the whey stays colorless. The microcapsules localized in the cheese curd need a release mechanism to color the cheese curd selectively. The ripening step provides a benefit as a turning point of the cheese-making process, in which the immature cheese turns to a matured and flavored cheese. One of the main flavor forming pathways in cheese during ripening involves lipolysis by lipases. These lipases can originate from milk, the starter lactic acid bacteria, non-starter lactic acid bacteria, and exogenous enzymes (Wilkinson et al., “Mechanisms of Incorporation and Release of Enzymes into Cheese During Ripening,” International Dairy Journal 15(6):817-830 (2005), which is hereby incorporated by reference in its entirety). Studies show that the addition of phospholipase to milk prior to cheese manufacturing enhances lipolysis and improves the cheese flavor (U.S. Pat. No. 7,931,9325 to Nielsen, which is hereby incorporated by reference in its entirety).

The lipid layer of the microcapsule shell is specifically broken down by these endogenous and exogenous lipases during cheese ripening (FIG. 2) and selectively colors the cheese matrix. To simulate the cheese making-process, microcapsules were added to whole milk. FIG. 9 shows the results of this simulated cheese making process for whole milk containing microcapsules. The components of the microcapsule shell and the density of the microcapsules are responsible for directing the microcapsules just to the curd. Table 2 shows the other formulations of the microcapsules that we tested, containing casein in the microcapsule shell. Although these other formulations contain casein, they were not able to partition into the curd. Instead, they floated on the surface of the whey supernatant (FIG. 10).

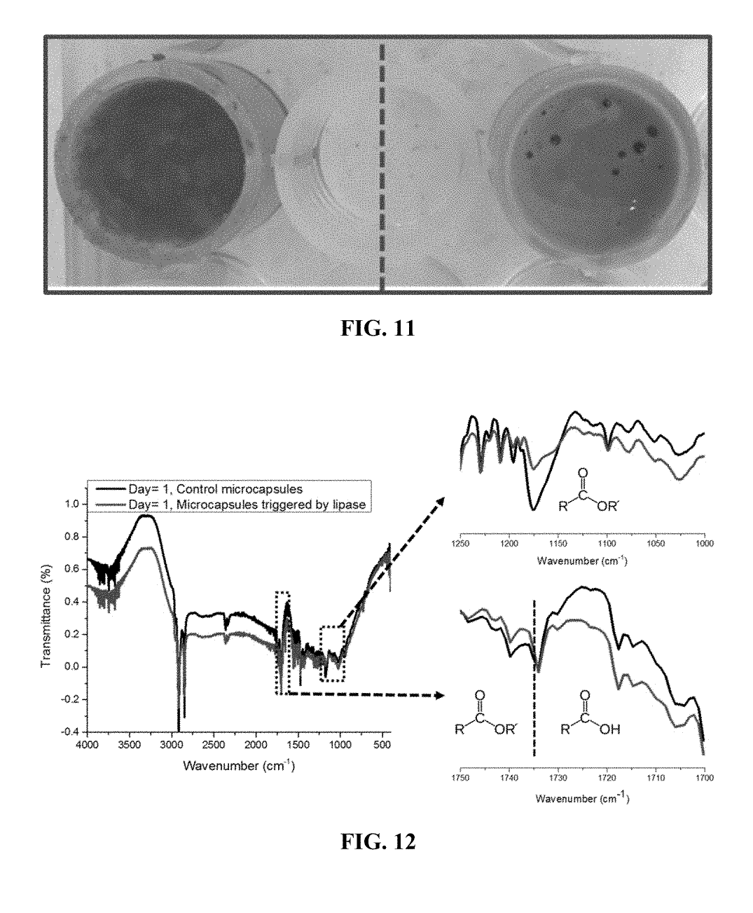

The best formulation for color partitioning used palmitic acid and beeswax (2:1) as the lipid layer of the microcapsule shell, as well as casein and poloxamer 338 in the protein-polymer layer. The cheese-ripening step was also simulated by adjusting the pH of the curd to 6.0, which is similar to the pH of Cheddar cheese just before the ripening step. The lipase was added to the curd and incubated at 26° C. for 14 days. The effect of lipase on the microcapsules and the release of color to the curd was next investigated. FIG. 11 shows the curd with lipase in comparison to the curd without lipase after 14 days incubation. The curd without lipase shows the microcapsules coagulated and creamed up on the surface of the curd, because the microcapsules are not broken by lipase. The curd with lipase, however, does not show any sign of the microcapsules creaming, because the lipase breaks down the shell and releases the color uniformly to the curd.

FIG. 12 shows the FTIR spectra for the curd with and without lipase after one day incubation at 26° C. There are two peaks in the region between 1000 and 1300 cm⁻¹ which are indicative of C—O bonds of esters. Both of these peaks show a lower intensity for the microcapsules triggered with lipase in comparison to the control (without lipase). This result proves the breakdown of ester bonds by lipase in the microcapsule shells. In addition, the peaks in the region between 1735 and 1750 cm⁻¹ are diagnostic peaks for the carbonyl group of esters. The results show a lower intensity of the peaks at this region for the microcapsules triggered with lipase. The peaks in the region between 1705 and 1720 cm⁻¹, however, show a higher intensity in the microcapsules triggered by lipase in comparison to the control. The decrease in the carbonyl group of esters and increase in the carbonyl group of carboxylic acids confirm de-esterification of the beeswax in the microcapsule shells by lipase and the formation of carboxylic acid in the curd.

The major component of beeswax is triacontanyl palmitate, a wax ester, which during the de-esterification reaction by lipase breaks down to long hydrocarbon chain alcohol and acid (FIG. 3). These are not volatile and do not interfere with the cheese flavor. Since breakdown of ester bonds in the microcapsules' shell structure loosens the shell, the entrapped bixin is released from the microcapsules and colors the curd selectively and uniformly. Therefore, an increase in the redness of the curds after 14 days incubation was expected. Table 3 shows the L*, a*, and b* values of the cheese

TABLE 3
L*, a*, and b* Values for the Cheese Curd Containing
Lipase-Triggered Microcapsules at 26° C.

| Day(s) | L* | a* | b* |
|---|---|---|---|
| 1 | 54.92 + 6.27^{a} | 23.20 + 0.79^{a} | 40.72 + 8.40^{a} |
| 3 | 47.03 + 2.31^{b} | 23.51 + 0.41^{b} | 43.39 + 4.65^{a} |
| 7 | 46.99 + 1.01^{c} | 25.79 + 1.94^{c} | 43.90 + 4.17^{a} |
| 14 | 41.37 + 7.41^{d} | 26.82 + 1.93^{d} | 43.76 + 3.37^{a} |

Equal lower case in the same column does not differ statistically at a 5% level by the t-test.

curd with lipase-triggered microcapsules. The lightness of the curd decreased significantly, while the redness of the curd increased significantly over the 14-day incubation period at 26° C. This shows that the color intensity increases in the curd containing lipase-triggered microcapsules during ripening.

### Discussion of Examples 1-5

Examples 1-5 provide an innovative microencapsulation design with a controlled-release platform for the targeted delivery and release of color. This microcapsule design provides an alternative method to isolate white whey from the Cheddar cheese-making process without the addition of external bleaching agents. The microcapsule shells are broken down during cheese ripening by lipases in the cheese curd and are shown to release the color evenly throughout the curd. The presence of casein, in combination with the other components in microcapsule architecture, directs the microcapsules to partition into the cheese curd and prevents them from being distributed into the whey.

The microcapsule shell of the present application is designed using compounds that naturally contain ester bonds. In future applications, this design could incorporate other compounds that are artificially modified to contain ester bonds. Thus, the composition of the shell is controllable and tunable, and can be optimized (Ravanfar et al., “Optimization of Ultrasound Assisted Extraction of Anthocyanins From Red Cabbage Using Taguchi Design Method,” J. Food Sci. Technol. 52(12):8140-8147 (2015), which is hereby incorporated by reference in its entirety) to use with other enzymes in other food systems or physiological media.

Additionally, this platform can be modified for further applications, such as targeted delivery of hydrophobic drugs. This enzyme-responsive platform can reduce the interference of lipase function on the oral bioavailability of hydrophobic drugs. For instance, increasing the beeswax ratio in the lipid layer of the microcapsule shell can guarantee the specificity of the cargo release, mostly in the presence of lipase. The lipase-degradable lipid layer of the microcapsule shell can reduce the inherent limitations of slow and incomplete dissolution of poorly water soluble drugs and facilitate the formation of solubilized fragments from which absorption may occur. Thus, bioresponsive platforms that offer substantial bioavailability advantages in a commercially relevant manner may be formulated.

### Materials and Methods for Examples 6-8

### Preparation of Microcapsules

The oil-soluble cargo was dispersed in an aqueous solution, which later turned to gel matrix, under stirring to prepare an oil-in-water (o/w) single emulsion. This single emulsion was then added dropwise to the lipid oil phase at 40-80° C. under vigorous stirring to prepare an o/w/o microemulsion. This o/w/o double emulsion was dispersed in a secondary aqueous solution, containing sodium caseinate and/or micellar casein, and a stabilizer using a high shear or high pressure homogenizer in an ice bath. This o/w/o/w triple microemulsion was spray-dried or freeze-dried. The lipid phase was solidified to form a lipid layer. Following the drying step, a polymer layer of casein-stabilizer was formed on top of the lipid layer.

### Example 6—Additional Microcapsule Gel Matrix Components

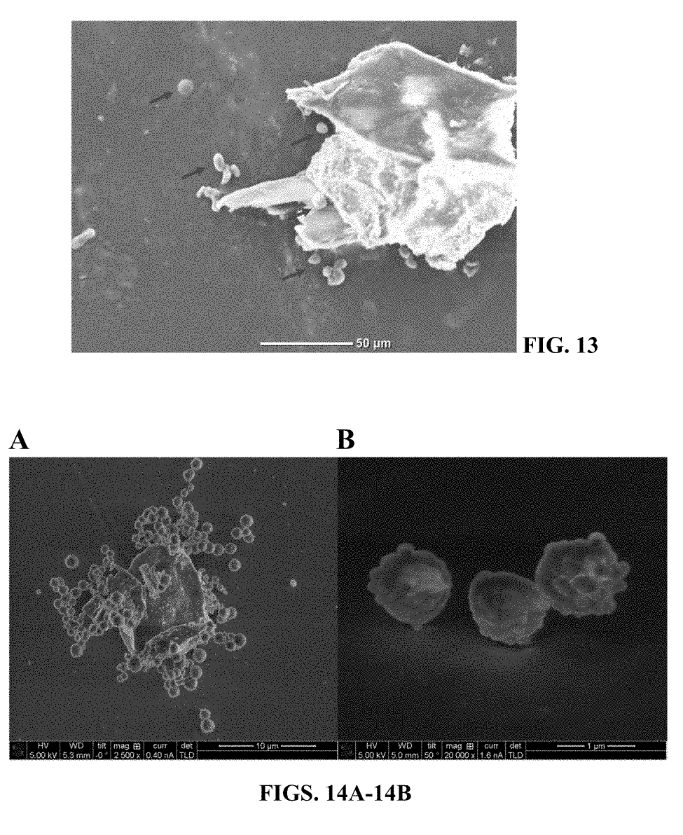

The interior gel matrix can be made of other synthetic or natural gels which are set in response to decrease of temperature and/or addition of salt, such as gelatin (FIG. 13), alginate, pectin, gellan gum, guar gum, amylose, starch, inulin, carrageenan, xanthan and/or their combination.

### Example 7—Additional Microcapsule Lipid Layer Components

The lipid layer of the microcapsule shell can contain most of the lipids with ester bonds. As described above, ester bonds the microcapsule lipid layer may be broken by lipase during the cheese ripening process to release the encapsulated color into the cheese matrix. This lipid layer can comprise other saturated or unsaturated fats such as glycerol monooleate (GMO), glycerol monostearate, palmitic acid, stearic acid, oleic acid, beeswax, palm oil, cocoa butter, coconut oil, vegetable oils, and/or their combination such as combination of beeswax/oleic acid, beeswax/stearic acid, palmitic acid/lecithin, and beeswax/lecithin (FIGS. 14A-14B). The applied temperature for preparing these microcapsules is maintained based on the lipid melting point. The lecithin can also be substituted with other emulsifiers such as egg lecithin, calcium stearoyl di laciate, polyglycerol ester, sorbitan ester, PG Ester, sugar ester, monoglyceride, acetylated monoglyceride, and lactylated monoglyceride.

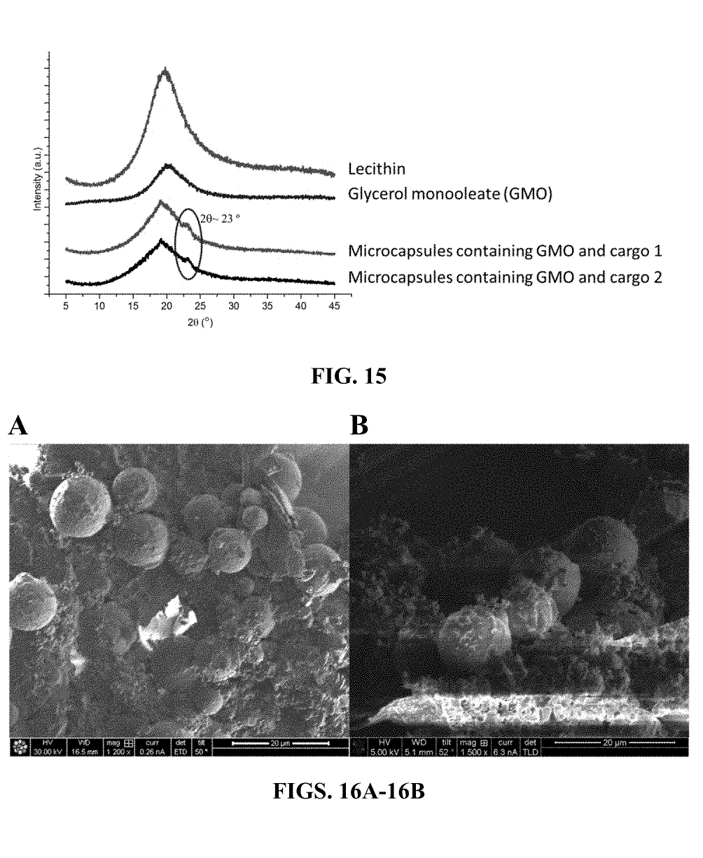

GMO is a polar amphiphilic, nontoxic, biodegradable, and biocompatible lipid, which is white and waxy at room temperature (Ericsson et al., “Glycerol Monooleate-Blood Interactions,” Colloids and Surfaces B: Biointerfaces 68(1):20-26 (2009), which is hereby incorporated by reference in its entirety). It is a well-characterized additive, used in the pharmaceutical and food industries since the 1950s (Chen et al., “Cubic and Hexagonal Liquid Crystals as Drug Delivery Systems,” BioMed Research International (2014), which is hereby incorporated by reference in its entirety). GMO is used as an antifoam agent in juice processing, and as a lipophilic emulsifier for w/o emulsions. It also serves as a moisturizer, flavoring agent and antifogging polymer additive (Plasman et al., “Polyglycerol Esters Demonstrate Superior Antifogging Properties for Films,” Plastics, Additives and Compounding 7(2):30-33 (2005), which is hereby incorporated by reference in its entirety). Previous works show that GMO stabilizes and protects antibiotics from hydrolysis (Sadhale et al., “Glyceryl Monooleate Cubic Phase Gel as Chemical Stability Enhancer of Cefazolin and Cefuroxime,” Pharmaceutical Development and Technology 3(4):549-556 (1998), which is hereby incorporated by reference in its entirety). When GMO is placed in the vicinity of water, it is reorganized into lipid bilayers forming a reversed micellar phase and three types of liquid crystalline phases (lamellar, reversed hexagonal, and the cubic phase), depending upon the temperature and water content (Shah et al., “Cubic Phase Gels as Drug Delivery Systems,” Advanced Drug Delivery Reviews 47(2):229-250 (2001), which is hereby incorporated by reference in its entirety). GMO is ideal for use in microencapsulation of heat-sensitive compounds, as its melting point is just ˜40° C., so heat used in microcapsule preparation will not degrade encapsulated colorants. Moreover, the cubic phase of GMO is stable from 20 to 70° C. This phase is formed between the lamellar and hexagonal phase, when GMO: water ratio is 7:3 (%, w/w) in the system (Shah et al., “Cubic Phase Gels as Drug Delivery Systems,” Advanced Drug Delivery Reviews 47(2):229-250 (2001), which is hereby incorporated by reference in its entirety). The structure of the cubic phase consists of a curved bi-continuous lipid bilayer extending in three dimensions. GMO cubic phase gel, with high heat stability, may potentially act as a heat capacitor in the shell of microcapsules. Its demonstrated protective properties make it an excellent matrix to protect the hydrophilic gel matrix. The X-ray diffraction (XRD) spectra of both GMO and lecithin show a broad peak at 2θ˜22°. The microcapsules' XRD spectra, however, show the formation of a new peak at 2θ˜23° (FIG. 15). The formation of this new peak confirms a transition in GMO from the lamellar phase to the cubic liquid crystalline phase after heating to 45° C. during microcapsule preparation (Engström et al., “A Study of Polar Lipid Drug Systems Undergoing a Thermoreversible Lamellar-to-Cubic Phase Transition,” International Journal of Pharmaceutics 86(2-3):137-145 (1992), which is hereby incorporated by reference in its entirety). The formation of the cubic phase results in an ordered structure. In comparison to other lipids, the cubic phase of GMO can incorporate a large amount of water, which provides a large interfacial area (Engström et al., “A Study of Polar Lipid Drug Systems Undergoing a Thermoreversible Lamellar-to-Cubic Phase Transition,” International Journal of Pharmaceutics 86(2-3):137-145 (1992), which is hereby incorporated by reference in its entirety). Therefore, the presence of the cubic phase of GMO in the shell structure of the microcapsules reduces the rate of the core diffusing out of the microcapsules. The cubic phase is also able to dissolve compounds of different polarities and accommodate higher doses inside the microcapsule core (Shah et al., “Cubic Phase Gels as Drug Delivery Systems,” Advanced Drug Delivery Reviews 47(2):229-250 (2001), which is hereby incorporated by reference in its entirety).

### Example 8—Additional Polymer Layer Components

The polymer layer should be vulnerable to protease and be disintegrated by rennet during the coagulation step of the cheese-making process. The presence of casein (sodium caseinate or micellar casein) in the polymer layer is crucial and guarantees the transport of microcapsules to the cheese curd along with the other casein molecules of the milk. However, the poloxamer can be substituted with other natural or synthetic stabilizers such as polysaccharides (FIGS. 16A-16B) (maltodextrin, pectin (citrus or beet), Acacia (Gum Arabic), agar-agar, ammonium alginate, calcium alginate, carob bean gum (Locust bean gum), ghondrus extract (Carrageenan), ghatti gum, guar gum, potassium alginate, sodium alginate, sterculia gum (Karaya gum), tragacanth (gum tragacanth)), proteins (eg. gelatin, ovalbumin, phycocyanins, bovine serum albumins), and other types of copolymers such as poloxamers. Maltodextrin is a hydrolyzed starch produced by partial hydrolysis of starch with acid or enzymes and has relatively low cost, neutral aroma and taste (de Barros et al., “Gum Arabic/Starch/Maltodextrin/Inulin as Wall Materials on the Microencapsulation of Rosemary Essential Oil,” Carbohydrate Polymers 101:524-532 (2014), which is hereby incorporated by reference in its entirety). Maltodextrins show low viscosity at high solids and are useful in formulating dehydrated encapsulated systems (Augustin et al., “Nano- and Micro-Structured Assemblies for Encapsulation of Food Ingredients,” Chemical Society Reviews 38(4):902-912 (2009), which is hereby incorporated by reference in its entirety). Maltodextrins reduce stickiness of the lipid microcapsules during spray-drying. The reduction in stickiness is because of the incorporation of simple sugars in formulations, which provides a higher glass transition temperature (Augustin et al., “Nano- and Micro-Structured Assemblies for Encapsulation of Food Ingredients,” Chemical Society Reviews 38(4):902-912 (2009), which is hereby incorporated by reference in its entirety). Studies have also shown that maltodextrin stabilize the betalain pigments through encapsulation using spray dryer (Kumar et al., “Stabilization of Bioactive Betalain Pigment From Fruits of Basella rubra L. Through Maltodextrin Encapsulation,” Madridge J. Food Tech. 1(1):66-70 (2016), which is hereby incorporated by reference in its entirety).

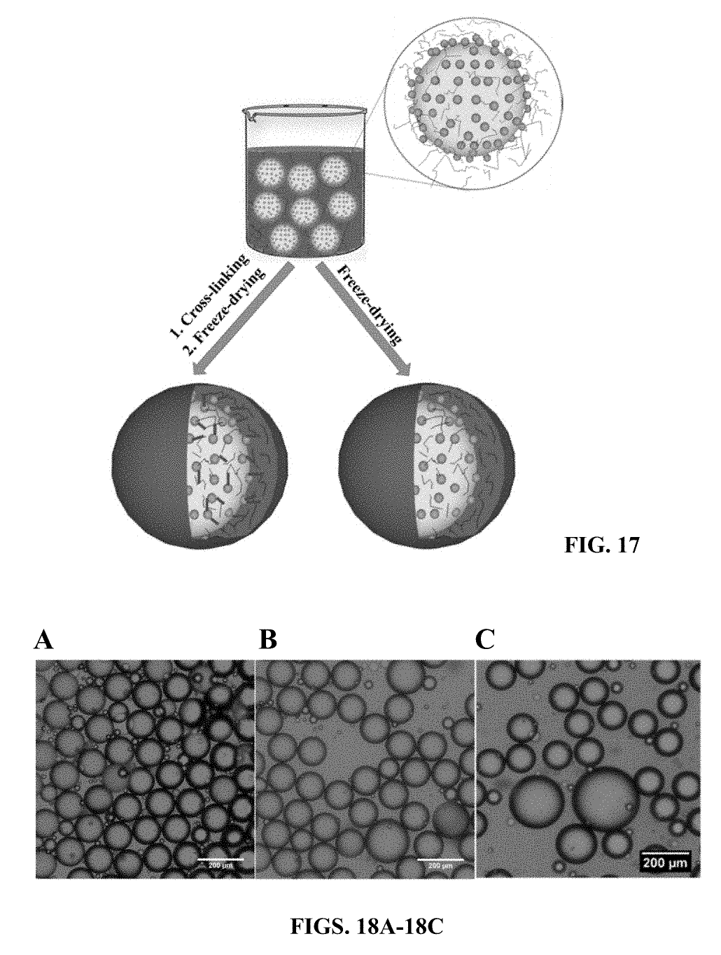

The outer polymer layer can also include cross-linking agents such as CaCl₂ or laccase enzyme to strengthen the physicochemical stability of the shell (FIG. 5). FIG. 17 shows the schematic of microcapsules with a lipid layer and an aqueous polymer layer (protein, polysaccharide). The microcapsules cross-linked with a cross-linking agent show more structured microcapsules (FIG. 17, bottom left schematic). These cross-links can be formed by CaCl₂, laccase, or any other cross-linking methods such as formation of disulfide bonds, amide bonds, peptide bonds to strengthen the protein-polysaccharide complex. The microcapsules without any cross-linking agent (FIG. 17, bottom right schematic). The size stability of the laccase-treated microcapsules indicates the ability of laccase to make the shell structure of the microcapsules stronger, likely through cross-linking of tyrosine and ferulic acid. Laccase can oxidize the ferulic acid groups through a free radical mechanism and form covalent cross-links between beet pectin molecules (polysaccharide-polysaccharide cross-links) (Sakai et al., “Oxidized Alginate-Cross-Linked Alginate/Gelatin Hydrogel Fibers for Fabricating Tubular Constructs With Layered Smooth Muscle Cells and Endothelial Cells in Collagen Gels,” Biomacromolecules 9(7):2036-2041 (2008), which is hereby incorporated by reference in its entirety). Laccase can also oxidize phenolic compounds in proteins, such as tyrosine and tryptophan-containing peptides (Mattinen et al., “Laccase-Catalyzed Polymerization of Tyrosine-Containing Peptides,” FEBS Journal 272(14):3640-3650 (2005), which is hereby incorporated by reference in its entirety), and form protein-protein cross-links (Mattinen et al., “Laccase-Catalyzed Polymerization of Tyrosine-Containing Peptides,” FEBS Journal 272(14):3640-3650 (2005), which is hereby incorporated by reference in its entirety) and protein-polysaccharide cross-links (Littoz et al., “Bio-Mimetic Approach to Improving Emulsion Stability: Cross-Linking Adsorbed Beet Pectin Layers Using Laccase,” Food Hydrocolloids 22(7):1203-1211 (2008), which is hereby incorporated by reference in its entirety). Conjugation of heated ß-lactoglobulin in whey with laccase is more probable than the intact ß-lactoglobulin and can enhance the hetero-conjugation with beet pectin and ß-lactoglobulin (Jung et al., “Laccase Mediated Conjugation of Sugar Beet Pectin and the Effect on Emulsion Stability,” Food Hydrocolloids 28(1):168-173 (2012), which is hereby incorporated by reference in its entirety.

Next, the cross-linking effect of CaCl₂ on shell structure and physicochemical stability of the microcapsules was investigated. The addition of CaCl₂ increases the strength of the microcapsule shell through the formation of calcium bridges between the negatively charged carboxyl groups (Kuuva et al., “Rheological Properties of Laccase-Induced Sugar Beet Pectin Gels,” Food Hydrocolloids 17(5):679-684 (2003), which is hereby incorporated by reference in its entirety). The CaCl₂-treated microcapsules show better stability in comparison to non-treated microcapsules. However, they merge together and form larger particles after 12 hours stirring and they are less stable than laccase-treated microcapsules (FIG. 18). Some authors note that certain salt concentrations enhance the formation of protein-polysaccharide complexes (Donato et al., “Heat-Induced Gelation of Bovine Serum Albumin/Low-Methoxyl Pectin Systems and the Effect of Calcium Ions,” Biomacromolecules 6(1):374-385 (2005); Sakai, S., & Kawakami, K., “Synthesis and Characterization of Both Ionically and Enzymatically Cross-Linkable Alginate,” Acta biomaterialia 3(4):495-501 (2007); and Sakai et al., “In Situ Simultaneous Protein-Polysaccharide Bioconjugation and Hydrogelation Using Horseradish Peroxidase,” Biomacromolecules 11(5):1370-1375 (2010), each of which is hereby incorporated by reference in its entirety). Addition of salt promotes the intramolecular electrostatic interactions between protein and polysaccharide in the shell, which helps to keep the shell more densely packed (Murphy et al., “Control of Thermal Fabrication and Size of β-Lactoglobulin-Based Microgels and their Potential Applications,” Journal of Colloid and Interface Science 447:182-190 (2015), which is hereby incorporated by reference in its entirety). Effective electrostatic interactions between protein molecules are also influenced by the ionic strength of the surrounding solution, and reduction in aggregation is expected with increasing ionic strength (Murphy et al., “Control of Thermal Fabrication and Size of β-Lactoglobulin-Based Microgels and their Potential Applications,” Journal of Colloid and Interface Science 447:182-190 (2015), which is hereby incorporated by reference in its entirety). The present application demonstrates that the stability of the CaCl₂-treated microcapsules is less than laccase-treated microcapsules, but their stability is more than control (non-treated microcapsules).

### Example 9—Thermal Stability of Laccase-Treated Microcapsules

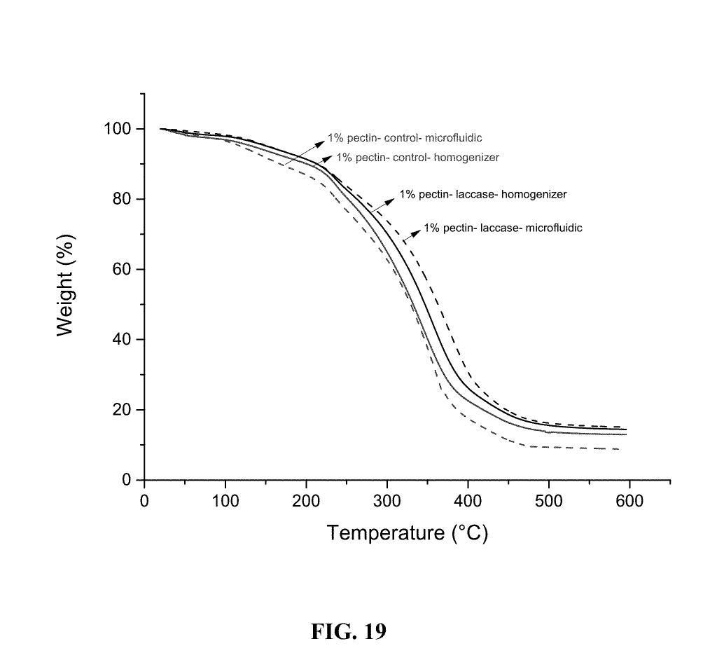

The thermal stability of the microcapsules was investigated by obtaining the thermogravimetric analysis (TGA) curves of laccase-treated microcapsules and untreated microcapsules (control) prepared by microfluidics and homogenization (FIG. 19). Weight loss in the range of 50-100° C. can be attributed to the loss of bound water. In this range, the control shows higher weight loss than the laccase-treated microcapsules. Weight loss in the range of 400-500° C. indicates further breakdown of residual shell materials. The TGA results clearly prove that laccase-treated microcapsules impede heat transfer and significantly increase the thermal stability of the microcapsules. These results also confirm that laccase induces the formation of highly structured microcapsule shell through conjugation of beet pectin and protein.

Thus, the encapsulated color is delivered primarily to the cheese curd and the recovered whey proteins remain white. Since the current industrial method to eliminate the yellow color of Cheddar cheese whey is using the oxidizing agents, such as hydrogen peroxide, obtaining the white whey through this enzyme-responsive microcapsules approach is of significant interest to the food industry. Exploiting this approach, the white whey is recovered without using any oxidizing agents and enhance the nutritive value and flavors in the white whey.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A microcapsule comprising:
a core comprising one or more hydrophobic agents dispersed in a gel matrix;
a proteolytically-cleavable outer polymer shell surrounding said core; and
an enzymatically-cleavable lipid layer between said core and said shell.

2. The microcapsule of claim 1, wherein the one or more hydrophobic agents is selected from the group consisting of coloring agents, vitamins, flavoring agents, antioxidants, drugs, imaging agents, and combinations thereof.

3. The microcapsule of claim 2, wherein the one or more hydrophobic agents is a coloring agent selected from the group consisting of a carotenoid and 2517oflg Natural Orange Color (paprika oleoresin).

4. The microcapsule of claim 3, wherein the coloring agent is a carotenoid selected from the group consisting of bixin, beta-carotene, alpha-carotene, gamma-carotene, zeaxanthin, lutein, and combinations thereof.

5. The microcapsule of claim 1, wherein the gel matrix comprises a gel which undergoes setting as a result of a change in temperature or ionic strength.

6. The microcapsule of claim 1, wherein the gel matrix comprises a polymer selected from the group consisting of alginate, pectin, κ-carrageenan, gelatin, gellan, agar, alginate/calcium, and combinations thereof.

7. The microcapsule of claim 6, wherein the gel matrix polymer is κ-carrageenan.

8. The microcapsule of claim 1, wherein the core further comprises a hydrophilic non-ionic surfactant.

9. The microcapsule of claim 1, wherein the enzymatically-cleavable lipid layer is made from a material selected from the group consisting of glycerol monooleate, glycerol monostearate, palmitic acid, beeswax, olieic acid, lecithin, calcium stearoyl di lactylate, polyglycerol ester, sorbitan ester, propylene glycol ester, sugar ester, monoglyceride, acetylated monoglyceride, lactylated monoglyceride, and combinations thereof.

10. The microcapsule of claim 9, wherein the enzymatically-cleavable lipid layer is made from a material selected from the group consisting of beeswax/oleic acid, beeswax/stearic acid, beeswax/palmitic acid/lecithin, beeswax/lecithin, and combinations thereof.

11. The microcapsule of claim 1, wherein the polymer shell is made from a material selected from the group consisting of homopolymers, co-polymers, polypeptides, polysaccharides, and combinations thereof.

12. The microcapsule of claim 11, wherein the polymer shell comprises casein/poloxamer 338.

13. The microcapsule of claim 11, wherein the polymer shell comprises casein and a polysaccharide.

14. The microcapsule of claim 13, wherein the polysaccharide is selected from the group consisting of maltodextrin, pectin, carboxymethylcellulose, dextran, chitosan, acacia (gum Arabic), agar-agar, ammonium alginate, calcium alginate, carob bean gum (Locust bean gum), ghondrus extract (Carrageenan), ghatti gum, guar gum, potassium alginate, sodium alginate, sterculia gum (Karaya gum), tragacanth (gum tragacanth), and combinations thereof.

15. The microcapsule of claim 1, wherein the polymer shell further comprises:
a cross-linking agent.

16. The microcapsule of claim 15, wherein the cross-linking agent is selected from the group consisting of one or more salts, enzymes, and combinations thereof.

17. The microcapsule of claim 16, wherein the cross-linking agent is one or more salts selected from the group consisting of MgCl₂, CaCl₂, Ca₃(PO₄)₂, and combinations thereof.

18. The microcapsule of claim 16, wherein the cross-linking agent is one or more enzymes selected from the group consisting of laccase, transglutaminase, sortase, peroxidase, tyrosinase, transferase, subtilisin, oxidoreductase, and combinations thereof.

19. A method of preparing a microcapsule, said method comprising:
dispersing one or more hydrophobic agents into an aqueous solution of a hydrophilic non-ionic surfactant and a gel matrix to produce an oil-in-water (o/w) single emulsion;
mixing the o/w single emulsion with one or more lipids to produce an oil-in-water-in-oil (o/w/o) double emulsion;
blending the o/w/o double emulsion with a secondary aqueous solution to produce an oil-in-water-in-oil-in-water (o/w/o/w) triple microemulsion;
drying the o/w/o/w triple microemulsion to form a dried triple microemulsion; and
incubating the dried triple microemulsion to form microcapsules each comprising one or more hydrophobic agents in a hydrophilic aqueous core surrounded by a proteolytically-cleavable outer polymer shell with an enzymatically-cleavable lipid layer between said core and said shell.

20-44. (canceled)

45. A method of selectively coloring cheese curd, said method comprising:
adding a plurality of microcapsules according to claim 1 to milk to produce a mixture, wherein the plurality of microcapsules comprise one or more hydrophobic coloring agents;
acidifying the mixture;
coagulating the acidified mixture to generate a curd fraction and a whey fraction;
separating the curd fraction from the whey fraction; and
ripening the curd to obtain a colored cheese curd.

46-56. (canceled)

57. A method of selectively delivering a hydrophobic agent to a food product, said method comprising:
providing a food product;
adding a plurality of microcapsules according to claim 1 to the food product to produce a mixture; and
exposing the mixture to proteolytic and enzymatic conditions to produce a modified food product treated with the one or more hydrophobic agents.

58-61. (canceled)

62. A method of treating a subject with one or more hydrophobic agents, said method comprising:
selecting a subject in need of treatment and
administering a plurality of microcapsules according to claim 1 to the selected subject, wherein the plurality of microcapsules are subjected to proteolytic and enzymatic conditions, thereby releasing the one or more hydrophobic agents in the subject.

63-64. (canceled)
